(19) United States
(12) Patent Application Publication
(10) Pub. No.: US 2014/0274684 A1
(43) Pub. Date: Sep. 18, 2014

(54) Compounds, Compositions, and Methods for Altering Behavior of Insects Or Other Organisms

(71) Applicant: BAYER CROPSCIENCE LP, Research Triangle Park, NC (US)

(72) Inventors: Tai-Teh WU, Chapel Hill, NC (US); Dick ROGERS, Chapel Hill, NC (US); Jian ZHANG, Durham, NC (US); Robert CROFT, Durham, NC (US); Chi Yu Roy CHEN, Raleigh, NC (US)

(73) Assignee: BAYER CROPSCIENCE LP, Research Triangle Park, NC (US)

(21) Appl. No.: 14/198,061

(22) Filed: Mar. 5, 2014

Related U.S. Application Data
(60) Provisional application No. 61/791,177, filed on Mar. 15, 2013.

(51) Int. Cl. A01N 35/02; A01N 65/10; A01N 65/22; C05G 3/02; A01N 43/50; A01N 43/36; A01N 43/56; A01N 65/24; A01N 47/44

(52) U.S. Cl. CPC A01N 35/02; A01N 65/24; A01N 65/10; A01N 65/22; A01N 47/44; A01N 43/50; A01N 43/36; A01N 43/56; C05G 3/02
USPC 504/100; 514/675; 424/739; 424/725; 424/745; 514/365; 514/396; 514/427; 514/406; 504/116.1; 504/101

(57) ABSTRACT

The disclosure provides for methods of repelling, directing, altering the behavior, and controlling an insect by utilizing a compound or composition described herein. The disclosure also provides for methods of promoting the health of an insect by repelling a pest that preys on insect and/or by providing an antibiotic or nutritional supplement composition to an insect. The disclosure also provides for a composition including at least one repelling, controlling, or directing compound or composition described herein together with an insecticide, herbicide, fungicide, or miticide. Compounds, compositions, seeds, and plants useful in these methods are also described.

### CROSS REFERENCE TO RELATED APPLICATION

This application claims the benefit of U.S. Provisional Application Ser. No. 61/791,177, filed Mar. 15, 2013, the content of which is herein incorporated by reference in its entirety.

### FIELD

The disclosure provides for methods of repelling, directing, altering the behavior of, and/or controlling an insect or other organism by utilizing a compound or composition described herein. The disclosure also provides for methods of promoting the health of an insect or other organism by repelling, directing, or controlling the insect or organism of interest to an area or place deemed beneficial to insect or organism, and/or by providing an antibiotic or nutritional supplement composition to the insect or organism of interest. The disclosure also provides for a composition including at least one repelling, controlling, or directing compound or composition described herein together with an insecticide, herbicide, fungicide, or other pesticide, as for example, a miticide. Compounds, compositions, seeds, and plants useful in these methods are also described.

### BACKGROUND

There is a need to develop new methodology or approaches to selectively and effectively repel, control, or direct insects. One approach of the present invention is to control the behavior of all or a selected group/subset of organisms such as insects by controlling, directing or repelling them away from certain locations to other locations that are beneficial to their health. Another aspect of the present invention is to protect insects or other organisms of interest from pests, predators, or other agents that have, or are at least believed to have, an adverse influence on insect or organisms health.

Some selectively controlling, repelling or directing agents are known. But many of the known repellant agents that are believed to exhibit a directing, controlling and/or repelling influence on insects of interest lack sufficient controlling, directing or repellent efficacy and associated longevity. Additionally, many of these same repellent agents fail to exhibit a repelling efficacy for the time desired, for example, four hours or more. For example, Mayer et al. evaluated the repellency profile of 240 non-pesticide chemical compounds. Hazards of Pesticides to Bees, Avignon (France), Sep. 7-09, 1999 Ed. INRS, Paris, 2001 (Les Colloques, n98), page 169. Of the 240 non-pesticide chemicals reviewed, Mayer et al. found that 11 compounds reduced the number of honeybee foragers at 1 hour of application. However, these same 11 compounds failed to confer repelling properties at 4 hours after application. Additionally, as described by Mayer et al., only a single compound was found to reduce the number of honey bee foragers after both 1 hour and 4 hours of application. These results highlight the importance of discovering additional compounds, compositions, or methodologies capable of better controlling or repelling insects over a longer period of time. To this end, the disclosed repelling, controlling, and directing compounds, compositions, and associated methods address this issue and have the ability to repel, control, and/or alter the behavior of insects over a longer period of time and with greater efficacy than previously recognized.

### SUMMARY

In an aspect, the disclosure provides for a method of repelling, controlling, and/or directing an insect from a seed, plant part, or plant, or even a locus such as park or field or golf course, or a place, a structure or portions or combinations of portions of any of the foregoing, with at least one compound from Formula I-IX herein below, wherein the at least one compound repels at least 80% of the insects for at least 8 hours.

In another aspect, the disclosure provides for a method of promoting the health of an insect by treating a seed, plant part, or plant with one or more of a compound or composition formulated to repel, control, or direct pests of an insect. In another, aspect, the disclosure provides for a method of promoting the health of an insect by providing a nutritional composition or an antibiotic composition to an insect.

In an aspect, the insect is a pollinating insect, such as a honeybee.

In another aspect, the repelling, controlling, or directing compound includes at least one C₆-C₁₅ ketone compound, an in one embodiment, preferably a C₈-C₁₅ ketone.

In another aspect, the C₆-C₁₅ ketone is selected from the group consisting of 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

In an aspect, a composition described herein further includes an insecticide, herbicide, fungicide, or other pesticide, such as for example, a miticide. In yet another aspect, the composition further includes one or more insecticidal active agents selected from the group consisting of acetamiprid, clothianidin (available from Bayer CropScience LP of RTP, North Carolina, under the trademark “PONCHO”), dinotefuran, imidacloprid (available from Bayer CropScience LP under the trademark “GAUCHO”), nitenpyram, thiacloprid, thiamethoxam, ethiprole, fipronil, and a combination of clothianidin and a biologic product of bacillus firmus (available from Bayer CropScience LP under the trademark “PONCHO/VOTIVO.” In another aspect, the miticide is selected from at least one compound selected from Formulas X-XII, herein below.

In yet another aspect, the composition further includes an agent selected from the group consisting of one or more of camphor, camphor oil, camphor powder, tea tree oil, essential oils of tea tree, pine oil, rosemary powder, and rosemary oil which also operate to provide directing, controlling or repelling in an additive and/or synergistic manner in combination with the repellent compounds of the Formula I-IX of the present invention.

In yet another aspect, the composition including at least one compound from Formula I-IX repels, directs, or controls a larger percentage of insects (in terms of the number of counted insects controlled of the same type or species, it does not refer to a larger percentage/number of species, though that may be possible as well) than an approximately equal percent by weight of a composition or compound selected from the group consisting of camphor oil, ajowan oil, camphor powder, and rosemary oil.

In an aspect, the repellant compound or composition of the present invention repels at least 95% of the insects for at least 24 hours.

### BRIEF DESCRIPTION OF THE FIGURES

FIG. 1 sets forth the feeding station arrangement for the honeybee repulsion experiment of Example 1. Panel (A) sets forth the bee cage positions on the left portion of panel (A) with the randomized feeding station positions on the right portion of panel (A). Panel (B) sets forth an alignment of the randomized feeding station positions with a distance of two meters between feeding stations.

FIG. 2 sets forth a honeybee feeding station with a solution of 2-decanone with a 50% sucrose solution after 8 hours.

FIG. 3 sets forth a honeybee feeding station with a 50% sucrose solution after 8 hours.

FIG. 4 sets forth a side by side comparison of the repulsion characteristics of (A) 2-decanone (left panel) with a 50% sucrose solution as compared to (B) a 50% sucrose control (right panel) on honeybees after a 8 hour period of time.

FIG. 5 sets forth the number of honeybees visiting feeding stations for T1 (control—50% sucrose), T2 (control—50% sucrose), T3 (control—50% sucrose), T4 (Camphor oil), T5 (Ajowan oil), T6 (Camphor powder), T7 (Rosemary oil), and T8 (2-Decanone) over a varied period of time. 50% sucrose was included with T4 (Camphor oil), T5 (Ajowan oil), T6 (Camphor powder), T7 (Rosemary oil), and T8 (2-Decanone).

FIG. 6 sets forth the mean number of honeybees visiting feeding station over a period of four hours for T1 (control—50% sucrose), T2 (control—50% sucrose), T3 (control—50% sucrose), T4 (Camphor oil), T5 (Ajowan oil), T6 (Camphor powder), T7 (Rosemary oil), and T8 (2-Decanone). 50% sucrose was included with T4 (Camphor oil), T5 (Ajowan oil), T6 (Camphor powder), T7 (Rosemary oil), and T8 (2-Decanone).

### DETAILED DESCRIPTION

### Insect Repelling, Controlling, or Directing Compound

The disclosure provides for an insect repelling, controlling, and/or directing compound or composition. In another aspect, a repelling, controlling, and/or directing compound or composition described herein repels all or a broad range of insects. In another aspect, a repelling, controlling, and/or directing compound or composition described herein repels some but not all insects.

In an aspect, an insect repelling, controlling, or directing compound or composition described herein can control or alter the behavior of an insect, for example a pollinating insect, such as a bee. In another aspect, the disclosure provides for a repelling, controlling, or directing compound or composition of Formula I:

[chemical structure]

In an aspect, R₁ and R₂ are independently selected from an alkyl, aryl, phenyl, substituted phenyl, fused phenyl, heterocyclic ring, aryl alkyl, vinyl, acetyl, vinyl alky, propargyl, and ally group.

In another aspect, R₁ and R₂ are independently selected from methyl, ethyl, propyl, isopropyl, cyclopropyl, butyl, iso-butyl, tert-butyl, pentyl, hexyl, heptyl, octyl, nonyl, decyl, undecyl and substituted or non-substituted C₂-C₁₄-alkyl, substituted or non-substituted C₂-C₁₄ alkenyl, a substituted or non-substituted C₂-C₁₄-alkynyl.

In a further aspect, R₁ is H and R₂ is an alkyl or aryl or R₁ is alkyl or aryl and R₂ is H.

In another aspect, an alkyl group is a straight chain, branched, cyclic, cyclic alkyl optionally substituted with halogen, such as F, Cl, Br, I, oxygen, hydroxyl, alkoxy, cyano, aryloxy, C═C, C≡C; nitrogen, NH2, alkyl amino, dialkyl amine trialkylamino; SH, alkylthio and oxidation states, arylthio and oxidation states; amido, monoalkylamino, dialkylamino, and ureido.

In yet another aspect, R₁ and R₂ can form a ring, such as a cycloalkyl ring, for example, a cyclohexyl, cycloheptyl, cyclopentyl, cyclopropyl, cyclobutyl, cyclooctyl, fused alkyl ring, such as camphor. In another aspect, the R₁ and R₂ ring is a phenyl ring optionally substituted with one or more of halogen, OH, alkoxy, cyano, amino alkylamino, dialkylamino, SH, alkylthio and oxidation states, pheoxy, formyl, alkylcarbonyl, alkoxycarbonyl, haloalkyl, haloalkoxy, polyhaloalkyl, polyhaloalkoxy, perhaloalkyl, perhaloalkoxy, amido, alkylamino, amino, dialkylamino, hydroxycarbonyl, alkyl carbonyl, aryl carbonyl, and alkoxycarbonyl groups.

In another aspect, R₁ and R₂ are linked together to form a substituted or unsubstituted (CH₂)₃, (CH₂)₄, (CH₂)₅, (CH₂)₆, (CH₂)₇, (CH₂)₈, (CH₂)₉, (CH₂)₁₀, (CH₂)₁₁, (CH₂)₁₂, and a (CH₂)₁₃ ring structure.

In yet another aspect R₁ methyl or ethyl and R₂ is selected from the group consisting of methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl.

In an aspect, the repelling, controlling, or directing compound is represented by Formula II, where R₁ and R₂ are defined above:

[chemical structure]

In an aspect, the repelling, controlling, or directing compound is represented by Formula III, where R₁ and R₂ are defined above:

[chemical structure]

In an aspect, the repelling, controlling, or directing compound is represented by Formula IV, where R₁ and R₂ are defined above:

[chemical structure]

In an aspect, the repelling, controlling, or directing compound is represented by Formula V, where R₁ and R₂ are defined above:

[chemical structure]

In an aspect, the repelling, controlling, or directing compound is represented by Formula VI, where R₁ and R₂ are defined above:

[chemical structure]

In an aspect, the repelling, controlling, or directing compound is represented by Formula VII, where R₁ and R₂ are defined above:

[chemical structure]

In an aspect, the repelling, controlling, or directing compound is represented by Formula VIII, where R₁ and R₂ are defined above and wherein R₃ and R₄ are individually selected from H, alkyl, methyl, ethyl, propyl, or butyl. In another aspect R₃ and R₄ can be any of the above referenced alkyl groups.

[chemical structure]

In an aspect, the repelling, controlling, or directing compound is represented by Formula IX, where R₁ and R₂ are defined above:

[chemical structure]

In another aspect, the disclosure provides for optically active and/or geometric isomers and/or salts thereof of compounds of Formula I-IX. In yet another aspect, the disclosure provides for metabolites, analogues, homologues, isomers, diastereomers, conjugate isomers, tautomers, and salts thereof of compounds of Formula I-IX. In another aspect, the methodology described herein can be practiced with one or more compounds represented by Formula I-IX.

In an aspect, the insect repelling, controlling, or directing compound or composition is selected from the group consisting of a ketone, such as a C₅-C₇ ketone, C₆-C₉ ketone, C₇-C₁₀ ketone, a C₈-C₁₂ ketone, C₁₀-C₁₂ ketone, a C₇-C₁₅ ketone, or a methyl ketone. In another aspect, the insect repelling, controlling, or directing compound is selected from one or more of 2-pentanone, cyclopentanone, 2-pentanimine, 2-hexanone, 3-hexanone, cyclohexanone, 2-methylcyclohexanone, 3-methylcyclohexanone, 4-methylcyclohexanone, 2-heptanone, 3-heptanone, 4-heptanone, heptyl, 1-acetyl, cycloheptanone, 2-octanone, 3-octanone, cyclooctanone, 2-nonanone, cyclononanone, 2-decanone (methyl-n-octyl ketone), 2-undecanone (methyl-n-nonylketone), 2-dodecanone, 1,3-dioxolane, 2-methyl-2-octyl, 2-trideconone, 2-tetradecanone, 2-pentadecanone, 2-hexadecanone, 2-heptadecanone, 2-nonanethione, cyclodeconone, decane, 2,2-dimethoxy, sulfur analog of 2-decanone, 2-decanimine, (+)-2-decanol, 2-decanol, 2,9-decanedione, 2,11-dodecanedione, 2,5-dodecanedione, 2,2-decanediol, 1-undecen-2-ol, 3-decanone, 4-decanone, 5-decanone, 9-methyl, decanal, ethanone, 1-[3-methyl-4-(trifluoromethyl)phenyl], ethanone, 2,2,2-trifluoro-1-phenyl, 5,9-undecadien-2-one, 6,10-dimethyl-, (5E)-, 2-pentadecanone, 4-methylcyclohexanone, p-methylacetophenone, propionphenone, 2-Hydroxyacetophenone, 2,9-decanedione, 2,11-dodecanedione, 2,5-dodecanedione, and 2-hydroxy acetophenone.

In an aspect, the insect repelling, controlling, or directing compound or composition is selected from the group consisting of a compound from 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

In another aspect, a repelling, controlling, or directing compound or composition is selected from the group consisting of Table 1:

TABLE 1

| | |
|---|---|
| [chemical structure] | [chemical structure] |
| [chemical structure] | [chemical structure] |
| [chemical structure] | [chemical structure] |
| [chemical structure] | [chemical structure] |
| [chemical structure] | [chemical structure] |
| [chemical structure] | [chemical structure] |
| [chemical structure] | [chemical structure] |
| [chemical structure] | [chemical structure] |
| [chemical structure] | [chemical structure] |
| [chemical structure] | [chemical structure] |
| [chemical structure] | [chemical structure] |
| [chemical structure] | [chemical structure] |
| [chemical structure] | [chemical structure] |
| [chemical structure] | [chemical structure] |
| [chemical structure] | [chemical structure] |
| [chemical structure] | [chemical structure] |
| [chemical structure] | |

[chemical structure]

In an aspect, methyl ketones of C₅-C₇ have a lower repellent activity than those with C₈-C₁₂. In an aspect, by “lower” it is meant that the methyl ketones of C₅-C₇ repel, control, or direct a lower percentage of insects of interest relative to C₈-C₁₂ ketones. In another aspect, by “lower” it is meant that the methyl ketones of C₅-C₇ repel, control, or direct an insect for a shorter period of time, less insects of interest, or combinations of interest relative to C₈-C₁₂ ketones. In another aspect, the volatility of methyl ketones of C₅-C₇ is higher than that of methyl ketones of C₈-C₁₂.

In another aspect, methyl ketones of C₅-C₇ have a lower repellent activity than those with C₈-C₁₅. In another aspect, the volatility of methyl ketones of C₅-C₇ is higher than that of methyl ketones of C₈-C₁₅.

In yet another aspect, the disclosure provides for one or more of an insect repelling, controlling, or directing compound or composition selected from the group consisting of pine oil, tea tree oil, essential oil of tea tree, densifolia leaf essential oil, essential oil of ocimum santum, systox, phenol, alkaloids, carum copticum oil, propionic anhydride, butyric anhydride, methyl salicylate, 6-hexatriacontene, stenpcereol, 27,28,29-trisnor-13-15-17-meratriene, samaderine E, phenylacetaldehyde, benzaldehyde, Swertia densifolia leaf essential oil, linalool, ambrette seed oil, cascarilla bark oil, leaf oil, cascarilla bark oil, rue oil, rue flower oil, terpineol, stearic acid, hydroquinone and octadecanal, methyl anthranilate, methyl anthranilate, creosote, acetic acid and propionic acid, N,N-diethyltoluamide, dimethyl phthalate, and isopropyl cinnamate. The disclosure also provides for one or more of an insect repelling, controlling, or directing compound or compound combinations selected from the group consisting of citronella (for example, Cymbopogon spp, Cymbopogon nardus, Cymbopogon winterianus and Cymbopogon citratus), eucalyptus (Eucalyptus spp.), lemon eucalyptus (Corymbia citriodora), cinnamon (Cinnamomum verum), castor (Ricinus communis), rosemary (Rosmarinus officinalis), cedar (Cedrus spp.), peppermint (Mentha piperita), clove (Syzygium aromaticum), geranium (Pelargonium graveolens), verbena (Verbena spp., Verbena officinalis), pennyroyal (Mentha pulegium), lavender (Lavandula spp.), pine (Pinus spp.), cajeput (Melaleuca spp.; Melaleuca leucadendra), basil (Ocimum basilicum), thyme (Thymus vulgaris), pandan (Pandanus amaryllifolius), allspice (Pimenta dioica), soybean (Glycine max), garlic (Allium sativum), DEET, Picaridin, p-Mentane-3,8-diol, Permethrin, Allethrin, Metofluthrin, Geraniol, Eugenol, Cinnamaldehyde, Alkaloids, p-cymene, linalool, α-pinene, β-pinene, sabinene, myrcene, α-phellandrene, α-terpinene, a α-terpineol (a component of tea tree oil and pine oil), α-ter, limonene, 1,8-cineole, y-terpinene, terpinolene, terpinen-4-ol and α-terpineol, copticum, and Ptychotis oil.

In an aspect, the compounds and compositions described herein exhibit a synergistic influence when combined. In another aspect, compounds of Formula I-IX exhibit a synergistic influence when combined. In another aspect, compounds 1-32 in Table 1 exhibit a synergistic influence when combined. In yet another aspect, these compounds produce an additive effect.

In an aspect, the insect repelling, controlling, or directing compound or compositions comprises, consists of, or consists essentially of any of the repelling, controlling, or directing compound or compositions described herein.

In another aspect, the disclosure provides for a composition comprising, consisting essentially of, or consisting of 2-decanone and rosemary oil. In another aspect, the disclosure provides for a composition comprising, consisting essentially of, or consisting of 2-decanone and camphor. In yet another aspect, the disclosure provides for a composition comprising, consisting essentially of, or consisting of 2-decanone, rosemary oil, and camphor. In an aspect, these compounds produce a synergistically effect. In yet another aspect, these compounds produce an additive effect.

In another aspect, the insect repelling, controlling, or directing compound or composition described herein works by influencing or altering the senses of an insect. In another aspect, the compound or composition alters the olfactory senses, taste, sight, tactile (e.g. burning or itch) or other physical characteristics of an insect, or in another aspect of the invention, the repelling, controlling or directing compound of the present invention can be combined with one or more compounds that act on one or more senses in a synergistic or additive manner, to affect and thereby control, direct or repel the insect across more than one sense.

In another aspect, the insect repelling, controlling, or directing compound, compound combination, or composition does not include heptanone, 2-heptanone, compounds that mimic the activity of 2-heptonone, 2-undecanone, 2-dodecanone, 2-trideconone, N,N-diethyl-m-toluamide (“DEET), benzaldehyde, phenol, or any combination thereof.

In an aspect, the insect repelling, controlling, or directing composition includes 2-decanone and not 2-heptanone. In an aspect, the composition includes 2-decanone and not 2-undecanone. In another aspect, the composition includes 2-decanone and not 2-dodecanone. In yet another aspect, the composition includes 2-decanone and not 2-trideconone. Yet in another aspect, the composition includes 2-decanone and not 2-heptanone, 2-undecanone, 2-dodecanone, or 2-trideconone.

In an aspect, the composition does not contain a neem plant, neem part thereof, neem oil, or neem extract.

### Methods of Repelling, Controlling, or Directing an Insect

In an aspect, the disclosure provides for a method of repelling, controlling, or directing an insect by utilizing a compound or composition described herein. In another aspect, the disclosure provides for a method of repelling, controlling, or directing an insect, or an insect of interest, for example a bee, by treating a seed, plant part, or plant with a compound or composition described herein.

In an aspect, a compound or composition described herein repels, controls, or directs all or a broad range of an insect of interest, for instance a bee. In another aspect, a compound or composition described herein repels, controls, or directs on a selective basis. In yet another aspect, the insect may be directed by coming into contact with a compound or composition described herein. In another aspect, an insect of interest, such as a bee, in a manner such that the insect is not in direct contact with a substance treated with the repellent, controlling, or directing compound or composition. In another aspect, a compound or composition described herein repels, controls, or directs an insect of interest, such as a bee, in a manner such that the insect has only minimal contact with a treated substance.

In an aspect, a compound or composition described herein repels, controls, or directs all or a broad range of an insect of interest, for instance a bee. In another aspect, a compound or composition described herein repels, controls, or directs on a selective basis. In yet another aspect, the insect may be directed by coming into contact with a compound or composition described herein. In another aspect, an insect of interest, such as a bee, in a manner such that the insect is not in direct contact with a substance treated with the repellent, controlling, or directing compound or composition. In another aspect, a compound or composition described herein repels, controls, or directs an insect of interest, such as a bee, in a manner such that the insect has only minimal contact with a treated substance.

In another aspect, the disclosure provides for a method of repelling, controlling, or directing an insect from a location or structure treated with a compound or composition described herein. In another aspect, the disclosure provides for a method of repelling, controlling, or directing an insect in connection with foraging and/or collecting nectar from a flower of a plant treated with a repelling, controlling, or directing compound or composition described herein. In another aspect, the disclosure provides for a method of treating any seed that may germinate into an attracting flower for an insect.

In another aspect, the disclosure provides for a method of directing an insect, for example a bee, away from a seed, plant part, plant, location, or structure treated with a chemical, insecticide, herbicide, or fungicide.

In yet another aspect, the disclosure provides for a method of repelling, controlling, or directing an insect from an area, substrate or substance while at the same time attracting an insect to a different area, substrate or substance. The disclosure provides for a method of treating an area, substrate, or substance with a repelling, controlling, or directing compound or composition described herein and at the same or different time treating a distinct area, substrate or substance with an insect attractant compound that is strategically placed at an optimized distance. In an aspect, such a methodology can help to increase repelling, controlling, or directing efficacy by repelling an insect from an area to be avoided while attracting the same insect to an area of interest. The following provides a non-limiting example of such a methodology:
(1) a seed, plant part, plant, area, location, or substance is treated with one or more repelling, controlling, or directing compounds or compositions described herein at “location 1” or “area 1” or portion thereof; and
(2) a bait station, other substance, location, or area is treated with one or more attractant compounds or compositions at “location 2” or “area 2” or portion thereof which is a predetermined or optimized distance from “location 1” or “area 1” or portion thereof.

In another aspect, a seed, plant part, plant, area, or substance is treated with one or more repelling, controlling, or directing compounds or compositions described herein at “area 1” or “location 1” or portion thereof and a seed, plant part, plant, area, or substance is treated with one or more attractant compounds or compositions at “area 2” or “location 2” or portion which is a predetermined or optimized distance away from “area 1” or “location 1” or portion.

In another aspect, a seed, plant part, plant, area, or substance is treated with at least one repelling, controlling, or directing compounds or compositions described herein at “field 1” or “structure 1” or portion thereof and a seed, plant part, plant, area, or substance is treated with an attractant compound at “field 2” or “structure 2” or portion thereof which is a predetermined or optimized distance away from “field 1” or “structure 1” or portion thereof.

In yet another aspect, “area 1,” “location 1,” “field 1,” or “structure 1” or portion thereof are a distance of about 0.1 meters, about 0.5 meters, about 1 meter, about 3 meters, about 5 meters, about 10 meters, about 25 meters, about 50 meters, about 100 meters, about 200 meters, or about 300 meters away from “area 2,” “location 2,” “field 2,” “structure 2,” or portion thereof. In another aspect, “area 1,” “location 1,” “field 1,” or “structure 1” or portion thereof are a distance apart that is sufficient to repel, direct, or control an insect from “area 1,” “location 1,” “field 1,” or “structure 1” or portion thereof and attract the insect to “area 2,” “location 2,” “field 2,” or “structure 2” or portion thereof.

In another aspect, one or more, two or more, three or more, or four or more “locations,” “areas,” “fields,” or “structures” or portions thereof can be treated with one or more repelling, controlling, or directing compounds or compositions or one or more attractant compounds or compositions.

In an aspect, an “area” or “location” is a field, including but not limited to woodland fields, and/or athletic “fields” such as football, soccer, baseball or similar fields, or larger “fields” such as golf courses and the like, crop site, bush, tree, lawn, waste area, and/or trash container. In an aspect, a “structure” is a bait, bait mechanism or holder, container, container designed to hold an insect, building, house, trap, trap designed to hold an insect, and/or interior or exterior of a residential or commercial building.

In yet another aspect, a compound or composition described herein is applied to a border or outer edge of a field, location, structure or dwelling or portions thereof. In another aspect, a compound or composition described herein is applied to the border or outer edge of a field or area or portion thereof prior to the application of seed to a field, at the time of seed planting, after seed planting, or combinations thereof. In another aspect, the seed is applied to a field or area by a mechanized planter, such as a tractor. In yet another aspect, a compound or composition described herein, such as a repelling, controlling, or directing compound or composition is dispersed via a tractor at the same time seed is planted, before seed is planted, after seed is planted, or combinations thereof. In another aspect, the field or area is not been tilled prior to seed application. In yet another aspect, the field has not been tilled for about 10 minutes to about 24 hours, about 1 hour to about 8 hours, about 24 hours to about 48 hours, about 24 hours to about one month, or about one month or more prior to application of a compound or composition described herein. The field or area may also contain vegetation, such a weeds, crops, or dandelions, prior to application of a compound or composition described herein. By applying a compound or composition described herein, such as a repelling, directing, or controlling compound, to a boarder or outer edge of a field or area, a zone or buffer can be created to keep an insect of interest, such as a bee, from penetrating the zone or buffer.

In another aspect, a compound or composition described herein is applied to the interior portion of an area or field. In another aspect, the field or area is cleared, for example by application of an herbicide, prior to seed planting. In yet another aspect, the field or area is treated with a herbicide for about 10 minutes to about 24 hours, about 1 hour to about 8 hours, about 24 hours to about 48 hours, about 72 hours to about one month, or about one month or more prior to application of a compound or composition described herein.

In an aspect, the percent of the compound on any composition or formulation is determined by the interplay of the effectiveness in the compound repellency, the medium or other components in which the compound is carried, the methods of application and the area that is being treated, when in terms of surface area or volume. For example, where the surface is a flat plate or wall, surface area may be used, and where the area is a room or other space, volume may be used to determine rates of applications.

### Methods of Promoting Insect Health

The disclosure also provides for a method of promoting the health of an insect, for example a bee, by utilizing a compound or composition described herein. In another aspect, the disclosure provides for a method of promoting the health of an insect, for example a bee, by treating a seed, plant part, or plant with a compound or composition described herein. In an aspect, a compound or composition described herein is applied, incorporated, or coated on a seed, plant part, or plant thereof.

In an aspect, the disclosure provides for a method of promoting the health of an insect, for example a bee, by repelling a predator and/or a pest that preys on insects or bees. In another aspect, a seed, plant part, or plant is treated with a compound or composition capable of repelling a predator and/or a pest that preys on insects, an insect, or bees. In yet another aspect, a seed, plant part, or plant is treated with:
(1) a first repelling, controlling, or directing compound or composition designed to repel, control, or direct an insect, such as a bee, and
(2) a second compound or composition designed to repel, control, direct or kill a predator or a pest of an insect, such as a bee.
   In an aspect, the first repelling, controlling, or directing compound or composition designed to repel, control, or direct an insect, for example, a bee and the second compound or composition designed to repel a predator or a pest of a bee are applied to a seed, plant part, or plant at the same time or at different times. In another aspect, the first repelling, controlling, or directing compound or composition designed to repel, control, or direct a bee and the second compound or composition designed to repel, control, direct, or kill a predator or a pest of a bee are applied to a seed, plant part, or plant in the same coating or in two, three, four, or five or more different coating steps. In another aspect, a pest is a mite, such as a Varroa mite or parasitic mite, as described herein. In another aspect, a pest is an ant, for example a wax ant. In another aspect, a pest is a dragonfly, or a bird, such as a kingbird or mockingbirds.

The disclosure also provides for a method of reducing infection or virus in an insect, for example a bee, by utilizing a compound or composition described herein. In another aspect, the disclosure provides for a method of reducing infection or virus in an insect, for example a bee, by treating a seed, plant part, or plant with a compound or composition described herein. In an aspect, the health of an insect is promoted in that a virus or infection is reduced or eliminated as the result of exposure to an antibiotic or nutritional compound or composition.

The disclosure also provides for a method of promoting the health of an insect, for example a bee, by delivering an antibiotic to promote the health of an insect or bee. In an aspect, the disclosure provides for a method of:
(1) treating a seed, plant part, or plant with a first attractant compound or composition designed to attract or control an insect, for example a bee, and
(2) an antibiotic or treatment compound or composition designed to promote the health of an insect, for example a bee.

In an aspect, the disclosure provides for a method of promoting the health of a bee hive by repelling a predator and/or a pest that preys on an insect, for example a bee. In another aspect, a seed, plant part, or plant is treated with a compound or composition capable of repelling a predator and/or a pest that prey on an insect, such as a bee. In yet another aspect, a seed, plant part, or plant is treated with:
(1) a first repelling, controlling, or directing a compound or composition designed to repel or control an insect, for example a bee, and
(2) a second compound or composition designed to repel, control, or direct a predator or a pest of an insect, for example a bee.

The disclosure also provides for a method of promoting the health of an insect, for example a bee, by repelling, controlling, or directing a mite. In an aspect, the disclosure provides for a method of:
(1) treating a seed, plant part, or plant with a first repelling, controlling, directing, or treating compound or composition designed to repel, control, direct, treat, attract or control a pest of an insect, for example a mite; and
(2) treat a seed, plant part, or plant with an antibiotic or treatment compound or composition designed to promote the health of an insect, for example a bee.

In an aspect, the first repelling, controlling, or directing compound or composition designed to repel, control, or control an insect, for example a bee and the second compound or composition designed to repel a predator or a pest of an insect, for example a bee are applied to a seed, plant part, or plant at the same time or at different times. In another aspect, the first repelling, controlling, or directing compound or composition designed to repel or control an insect, for example a bee, and the second compound or composition designed to repel, control, or direct a predator or a pest of an insect, for example a bee, are applied to a seed, plant part, or plant in the same coating or in two or more different coatings. In another aspect, a pest is a mite as described herein. In yet another aspect, the pest to be repelled, controlled, or directed is one detailed in U.S. Publication No. 20110171324 or U.S. Publication No. 20120157512, the contents of both which are incorporated by reference in their entirety. In another aspect, the pathogen or virus associated with the pest is reduced or eliminated from a bee or bee hive by repelling or controlling a predator or a pest of a bee.

The disclosure also provides for a method of promoting the health of an insect hive, for example a bee hive, by delivering an antibiotic or nutrition supplement to promote the health of an insect or bee. In an aspect, the disclosure provides for a method of:
(1) treating a seed, plant part, or plant with first attractant compound or composition designed to attract or control an insect, for example a bee, and
(2) an antibiotic or nutrition supplement or treatment compound or composition designed to promote the health of an insect, for example a bee.
   In an aspect, the nutrition supplement is one detailed in U.S. Publication No. 20090162482, the contents of which are incorporated by reference in its entirety.

In another aspect, the disclosure provides for a method of promoting the health of an insect hive, for example a bee hive, wherein an insect makes contact with a composition containing an antibiotic or nutrition supplement and transfers the antibiotic or nutrition supplement to the hive. In another aspect, the insect makes contact with a composition containing an insect attractant and an antibiotic or nutrition supplement.

In another aspect, the compounds or compositions described herein can be used in conjunction with methods and compositions of treating insect diseases via plant transcribed molecules, for example, those described in U.S. Patent Application No. 2012/0157512, which is herein incorporated by reference in its entirety.

### Repelling, Controlling, or Directing an Insect

In an aspect, a compound or composition described herein repels, controls, or directs an insect of interest such that the insect is not in direct contact with a seed, plant part, plant, area, or other substance treated with a compound or composition described herein. In another aspect, a compound or composition described herein repels an insect of interest such that the insect is not in direct contact with pollen. In yet another aspect, a compound or composition described herein repels, controls, or directs an insect of interest such that the insect does not land and collect nectar.

In another aspect, a compound or composition described herein repels, controls, or directs an insect of interest such that the insect is not in direct contact with a treated substance for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more. In yet another aspect, a compound or composition described herein repels, controls, or directs an insect of interest such that the insect is not in direct contact with a treated substance for a desired period of time, for example, a planting, growing, or harvesting season.

In another aspect, a compound or composition described herein repels, controls, or directs an insect of interest such that the insect is at least about 1 cm, at least about 5 cm, at least about 10 cm, at least about 100 cm, at least about 0.2 meters, at least about 0.5 meters, at least about 1 meter, at least about 2 meters, at least about 5 meters, at least about 10 meters, at least about 25 meters, at least about 50 meters, at least about 100 meters, at least about 200 meters, or at least about 300 meters or more away from a seed, plant part, plant, area, or other substance treated with a repelling, controlling, or directing compound or composition described herein. In yet another aspect, a compound or composition described herein repels an insect of interest such that the insect is at least about 1 cm, at least about 5 cm, at least about 10 cm, at least about 100 cm, at least about 0.2 meters, at least about 0.5 meters, at least about 1 meter, at least about 2 meters, at least about 5 meters, at least about 10 meters, at least about 25 meters, at least about 50 meters, at least about 100 meters, at least about 200 meters, or at least about 300 meters or more away from a seed, plant part, plant, area, or other substance treated with the repelling, controlling, or directing compound or composition described herein for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more, or desired period of time, for example, a planting, growing, or harvesting season.

In another aspect, a compound or composition described herein repels, controls, or directs an insect of interest such that the insect is at least about 1 cm to about 10 cm, about 10 cm to about 100 cm, about 100 cm to about 500 cm, about 1 meter to about 5 meters, about 5 meters to about 10 meters, about 10 meters to about 50 meters, about 50 meters to about 100 meters, about 100 meters to about 250 meters, and about 250 meters to about 500 meters or more away from a seed, plant part, plant, area, or other substance treated with a compound or composition described herein. In yet another aspect, a compound or composition described herein repels an insect of interest in a manner such that the insect is at least about 1 cm to about 10 cm, about 10 cm to about 100 cm, about 100 cm to about 500 cm, about 1 meter to about 5 meters, about 5 meters to about 10 meters, about 10 meters to about 50 meters, about 50 meters to about 100 meters, about 100 meters to about 250 meters, and about 250 meters to about 500 meters or more away from a seed, plant part, plant, area, or other substance treated with a compound or composition described herein for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more, or desired period of time, for example, a planting, growing, or harvesting season.

In another aspect, a compound or composition described herein controls or directs an insect of interest, such as a bee, for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, about 3 months or more, or designated a planting, growing, or harvesting season.

In another aspect, one or more additional repellent, controlling, or directing compounds or compositions can be added to a repellency composition described herein in a manner that modifies or increases repellency via additive efforts, synergistic efforts, and combinations thereof. A compound or composition described herein can also be formulated in a delayed release formulation or controlled release formulation which can delay or control the release of the repelling compound or composition. In another aspect, a compound or composition described herein can also be formulated in a rapid release formulation which can expedite the release of the repelling, controlling, or directing compound or composition.

In an aspect, a method of “repelling” refers to the ability of a compound or composition described herein to influence or alter the behavior of an insect, for example, a bee, away from an area, location, structure, seed, plant, plant part, or substance of interest. In order to be classified as “repelling” according to an aspect of the disclosure, it is not necessary that 100% of the insects, pollinating insects, pests, or mites be directed away from an area, location, structure, seed, plant, plant part, or substance of interest. In yet another aspect, an insect is “repelled” if at least 50%, at least 75%, at least 90%, at least 95%, or at least 98% of the insects are directed away from an area, location, structure, seed, plant, plant part, or substance of interest.

In another aspect, a method of “directing” refers to the ability of a compound or composition described herein to influence the behavior or movement of an insect, for example a bee, in a given direction. In order to be classified as “directing” according to an aspect of the disclosure, it is not necessary that 100% of the insects, pests, or other animals be directed away from an area, location, structure, seed, plant, plant part, or substance of interest. In yet another aspect, an insect is “directed away” if at least 50%, at least 75%, at least 90%, at least 95%, or at least 98% of the insects are directed away from an area, location, structure, seed, plant, plant part, or substance of interest.

In an aspect, a method of “controlling” refers to the ability of a compound or composition described herein to control or alter the behavior of an insect, for example a bee. In order to be classified as “controlling” according to an aspect of the disclosure, it is not necessary that 100% of the insects, pests, or other animals be controlled away from an area, location, structure, seed, plant, or substance of interest. In yet another aspect, an insect is “controlled” if at least 50%, at least 75%, at least 90%, at least 95%, or at least 98% of the insect behavior is altered or controlled relative to an area, location, structure, seed, plant, or substance of interest.

In an aspect, a compound or composition described herein is applied, incorporated, or coated on a seed, plant part, or plant thereof.

### Treatment of a Seed, Plant Part, or Plant

In an aspect, a compound or composition described herein is applied to a plant, crop, seed, or plant part thereof in a single application step. In another aspect, a composition described herein is applied to a plant, crop, seed, or plant part thereof in multiple application steps, for example, two, three, four, five or more application steps. In another aspect, the second, third, fourth, or fifth or more application steps may be with the same or different compositions. The methods described herein also provide for an aspect where multiple application steps are excluded.

In another aspect, a compound or composition described herein is applied to a plant, crop, seed, or plant part thereof at the time of planting to about 30 minutes, about 30 minutes to about 1 hour, about 1 hour to about 4 hours, about 4 hours to about 12 hours, about 1 hour to about 1 day, about 1 day to about 5 days, about 5 days to about 10 days, about 10 days to about 20 days, about 15 days to about 30 days, about 30 to about 100 days, or any combination thereof. In yet another aspect, a compound or composition described herein is applied to a plant, crop, seed, or plant part thereof in one or more application intervals of about 30 minutes, about 1 hour, about 2 hours, about 6 hours, about 8 hours, about 12 hours, about 1 day, about 5 days, about 7 days, about 10 days, about 12 days, about 14 days, about 21 days, or about 28 days.

In an aspect, a compound or composition described herein is applied to a plant, crop, seed, or plant part thereof one or more times during a planting, growing, or harvesting season. In another aspect, a compound or composition described herein is applied to a plant, crop, seed, or plant part thereof in one, two, three, four, or five or more times during a planting, growing, or harvesting season. In another aspect, a compound or composition described herein is applied to a plant, crop, seed, or plant part thereof only one time, no more than two times, or no more than three times during a planting, growing, or harvesting season. In yet another aspect, a compound or composition is applied in a single step to a seed. In yet another aspect, a seed described herein is planted in a one-pass application step.

In yet another aspect, a compound or composition described herein is applied to a plant, crop, seed, or plant part thereof prior to planting, at planting, after planting or combinations thereof. In another aspect, a compound or composition described herein is applied to a plant, crop, seed, or plant part thereof when an insect described herein is likely to be foraging or harvesting nectar or pollen from a flower or plant.

In an aspect, a compound or composition described herein is applied to a seed only prior to planting. In another aspect, a compound or composition described herein is applied to a seed during the planting process. In yet another aspect, a compound or composition described herein is applied in an in furrow process. In another aspect, a compound or composition described herein can be applied during bloom, for example, in orchards.

In another aspect, a compound or composition described herein is applied to a plant, crop, seed, or plant part thereof in an application regimen at about 1 hour to about 3 hours after the first application and followed by a second application at about 3 hours to about 6 hours; at about 1 hour to about 3 hours after the first application and followed by a second application at about 12 hours to about 24 hours about 1 to about 7 days after the first application and followed by a second application at about 10 to about 14 days.

In another aspect, the disclosure provides for pre-plant, pre-emergent, post-emergent, application steps or combinations thereof. In another aspect, a compound or composition described herein is first applied in a pre-plant step and followed by one or more pre-emergent or post-emergent steps. In yet another aspect, the disclosure provides for only a pre-plant step.

In another aspect, a compound or composition described herein is applied to a plant, crop, seed, or plant part thereof during the daytime hours. In another aspect, a compound or composition described herein is not applied to a structure plant, crop, seed, or plant part thereof at night. In yet another aspect, the application of a compound or composition described herein is optimized based on when an insect, for example a bee, would most likely forage on a plant or crop. In another aspect, the application of a compound or composition described herein is optimized based on when an insect, for example a bee, would most likely be exposed to a harmful substance or to a pest. In another aspect, a compound or composition described herein can be applied during non-planting timing.

In another aspect, a compound or composition described herein is applied to a plant, crop, seed, or plant part thereof in a manner that is sufficient to repel an insect, for example a bee.

Seeds, plant parts, or plants which can be treated by the methods described herein include, for example, seeds, plant parts, or plants that are treated with insecticides, pesticides, or fungicides that are harmful to pests or insects, for example, bees. In an aspect, a seed is selected from the group consisting of a corn, cotton, sorghum, potato, oat, rye, barley, wheat, soybean, sugarbeet, potato, or vegetable. In an aspect, the seed is corn seed. Examples of corn seeds capable of being used in the methods described herein include, for instance, sweet corn (for example, zea mays convar. saccharata var. Rugosa), silver queen corn, golden bantam, early sunglow, indian corn, sugar corn, pole corn, field corn, dent corn, flint corn, flour corn, blue corn (for example, Zea mays amylacea), pop corn, and waxy corn. In another aspect, a plant part or plant is selected from the above plant part or plant varieties.

Method described herein can be used in the treatment of genetically modified organisms (GMOs), e.g. plants or seeds. Genetically modified plants (or transgenic plants) are plants of which a heterologous gene has been stably integrated into genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, cosuppression technology or RNA interference—RNAi—technology). A heterologous gene that is located in the genome is also called a transgene. A transgene that is defined by its particular location in the plant genome is called a transformation or transgenic event.

In an aspect, plants can be obtained by traditional breeding and optimization methods or by biotechnological and recombinant methods, or combinations of these methods, including the transgenic plants and including the plant varieties which are capable or not capable of being protected by Plant Breeders' Rights.

In another aspect, plant species and plant varieties which are found in the wild or which are obtained by traditional biological breeding methods, such as hybridization or protoplast fusion, and parts of these species and varieties are treated. In a further preferred embodiment, transgenic plants and plant varieties which were obtained by recombinant methods, if appropriate in combination with traditional methods (genetically modified organisms) and their parts are treated.

Plant parts should be understood as meaning all above ground and subsoil parts and organs of plants, such as shoot, leaf, flower, root, leaves, needles, stalks, stems, fruiting bodies, fruits and seeds, tubers and rhizomes. Plant parts also include harvested crops, and also vegetative and generative propagation material, for example cuttings, tubers, rhizomes, slips and seeds.

Seeds, plant parts, and plants may be treated with the described compounds or compositions by applying the compounds or compositions directly to the seed, plant part, or plant. In another aspect, the seed, plant part, or plant may be treated indirectly, for example by treating the environment or habitat in which the seed, plant part, or plant is exposed to. Conventional treatment methods may be used to treat the environment or habitat including dipping, spraying, fumigating, chemigating, fogging, scattering, brushing on, shanking or injecting.

In an aspect, a compound, composition, or compound combination described herein is applied to a seed at a rate of about 0.1-8.0 oz/cwt (ounces/hundredweight), about 2-7.0 oz/cwt, about 4-6.5 oz/cwt, about 5-6.5 oz/cwt, about 0.5-4.0 oz/cwt, about 1.0-3.5 oz/cwt, about 1.5-3.0 oz/cwt, about 2.0-3.0 oz/cwt, about 2.0-2.5 oz/cwt, or about 0.2 oz/cwt, about 0.5 oz/cwt, about 0.75 oz/cwt, about 1.0 oz/cwt, about 1.5 oz/cwt, about 2.0 oz/cwt, about 2.5 oz/cwt, about 3.0 oz/cwt, about 3.5 oz/cwt, about 4.0 oz/cwt, about 4.5 oz/cwt, about 5.0 oz/cwt, or about 0.2 oz/cwt or more, about 0.5 oz/cwt or more, about 0.75 oz/cwt or more, about 1.0 oz/cwt or more, about 1.5 oz/cwt or more, about 2.0 oz/cwt or more, about 2.5 oz/cwt or more, about 3.0 oz/cwt or more, about 3.5 oz/cwt or more, about 4.0 oz/cwt or more, about 4.5 oz/cwt or more, about 5.0 oz/cwt, about 6.0 oz/cwt, or about 7.0 oz/cwt or more. In yet another aspect, a composition described herein is applied to a seed in a manner sufficient to convey the desired property, for example, repellency.

### Repelling, Controlling, and Directing Compound and Composition Properties

In an aspect, a repelling, controlling, or directing compound or composition described herein is capable of repelling, controlling, or directing an insect, for example a bee, described herein for at least about 30 minutes, about 1 hour, about 2 hours, 3 about hours, about 4 hours, about 5 hours, about 8 hours, about 10 hours, about 15 hours, about 20 hours, about 24 hours, about 48 hours, about 72 hours, about 7 days, about two weeks, about one month, about two months, or about three months or more. In another aspect, a repelling, controlling, or directing compound or composition described herein is capable of repelling, controlling, or directing an insect during a complete or partial growing, planting, or harvesting season. In another aspect, a repelling, controlling, or directing compound or composition described herein repels, controls, or directs an insect, for example a bee, by at least about 20% or more, about 30% or more, about 40% or more, about 50% or more, about 60% or more, about 75% or more, about 90% or more, about 95% or more, about 98% or more, or about 99% or more relative to a compound or composition that does not contain an effective amount of a repelling, controlling, or directing compound or composition described herein. In another aspect, a repelling, controlling, or directing compound or composition described herein repels or controls an insect, for example a bee, by at least about 20% or more, about 30% or more, about 40% or more, about 50% or more, about 60% or more, about 75% or more, about 90% or more, about 95% or more, about 98% or more, or about 99% or more for at least about 30 minutes, about 1 hour, about 2 hours, about 3, hours, about 4 hours, about 5 hours, about 8 hours, about 10 hours, about 15 hours, about 20 hours, about 24 hours, about 48 hours, about 72 hours, about 7 days, about two weeks, about one month, about two months, about three months or more, or during a complete or partial growing, planting, or harvesting season relative to a compound or composition that does not contain an effective amount of a repelling, controlling, or directing compound or composition described herein. In yet another aspect, a repelling or controlling compound or composition described herein repels or controls an insect, for example a bee, by at least 95% or more, 96% or more, 97% or more, 98% or more, 99% or more, or 100% for at least about 30 minutes, about 1 hour, about 2 hours, about 3, hours, about 4 hours, about 5 hours, about 8 hours, about 10 hours, about 15 hours, about 20 hours, about 24 hours, about 48 hours, about 72 hours, about 7 days, about two weeks, about one month, about two months, about three months or more, or during a complete or partial growing, planting, or harvesting season relative to a compound or composition that does not contain an effective amount of a repelling, controlling, or directing compound or composition described herein.

In yet another aspect, a repelling, controlling, or directing compound or composition described herein repels, controls, or directs an insect by about 10% to about 100%, about 20% to about 100%, about 30% to about 100%, about 40% to about 100%, about 50% to about 100%, about 60% to about 100%, about 70% to about 100%, about 80% to about 100%, about 10% to about 90%, about 20% to about 90%, about 30% to about 90%, about 40% to about 90%, about 50% to about 90%, about 60% to about 90%, about 70% to about 90%, about 10% to about 80%, about 20% to about 80%, about 30% to about 80%, about 40% to about 80%, about 50% to about 80%, or about 60% to about 80%, about 10% to about 70%, about 20% to about 70%, about 30% to about 70%, about 40% to about 70%, or about 50% to about 70%, relative to a compound or composition that does not contain an effective amount of a repelling, controlling, or directing compound or composition described herein.

In an aspect, a repelling, controlling, or directing compound or composition disclosed herein reduces insect interaction with a mammal, pest, predator, plant, structure, and/or location. In an aspect, a repelling, controlling, or directing compound or composition described herein is capable of reducing the interaction of an insect, for example a bee, with a mammal, pest, predator, plant, structure, and/or location for at least 30 minutes, 1 hour, 2 hours, 3, hours, 4 hours, 5 hours, 8 hours, 10 hours, 15 hours, 20 hours, 24 hours, 48 hours, 72 hours, 7 days, two weeks, one month, two months, three months or more or a planting, growing, or harvesting season. In another aspect, a repelling, controlling, or directing compound or composition described herein is capable of reducing the interaction of an insect, for example a bee, with a mammal, pest, predator, plant, structure, and/or location by at least about 20% or more, about 30% or more, about 40% or more, about 50% or more, about 60% or more, about 75% or more, about 90% or more, about 95% or more, about 98% or more, or about 99% or more relative to a compound or composition that does not contain an effective amount of a repelling, controlling, or directing compound or composition described herein. In another aspect, a repelling, controlling, or directing compound or composition described herein reduces the interaction of an insect, for example a bee, with a mammal, pest, predator, plant, structure, and/or location by at least about 20% or more, about 30% or more, about 40% or more, about 50% or more, about 60% or more, about 75% or more, about 90% or more, about 95% or more, about 98% or more, or about 99% or more for at least 30 minutes, 1 hour, 2 hours, 3, hours, 4 hours, 5 hours, 10 hours, 15 hours, 20 hours, 24 hours, 48 hours, 72 hours, 7 days, two weeks, one month, two months, three months or more a planting, growing, or harvesting season relative to a compound or composition that does not contain an effective amount of a repelling, controlling, or directing compound or composition described herein. In yet another aspect, a repelling, controlling, or directing compound or composition described herein reduces the interaction of an insect with a mammal, pest, predator, plant, structure, and/or location by at least 95% or more, 96% or more, 97% or more, 98% or more, 99% or more, or 100% for at least about 30 minutes, about 1 hour, about 2 hours, about 3 hours, about 4 hours, about 5 hours, about 8 hours, about 10 hours, about 15 hours, about 20 hours, about 24 hours, about 48 hours, about 72 hours, about 7 days, about two weeks, about one month, about two months, about three months or more or a planting, growing, or harvesting season relative to a compound or composition that does not contain an effective amount of a repelling, controlling, or directing compound or composition described herein.

In another aspect, a repelling, controlling, or directing compound or composition described herein reduces an ability of an insect to obtain a meal and/or nectar from a plant. In an aspect, a repelling compound or composition reduces an ability of an insect, for example a bee, to obtain a meal and/or nectar from a plant for at least about 30 minutes, about 1 hour, about 2 hours, about 3 hours, about 4 hours, about 5 hours, about 8 hours, about 10 hours, about 15 hours, about 20 hours, about 24 hours, about 48 hours, about 72 hours, about 7 days, about two weeks, about one month, about two months, about three months or more or a planting, growing, or harvesting season. In another aspect, a repelling, controlling, or directing compound or composition reduces an ability of an insect, for example a bee, to obtain a meal and/or nectar from a plant for at least about 20% or more, about 30% or more, about 40% or more, about 50% or more, about 60% or more, about 75% or more, about 90% or more, about 95% or more, about 98% or more, or about 99% or more relative to a compound or composition that does not contain an effective amount of a repelling, controlling, or directing compound or composition described herein. In another aspect, a repelling, controlling, or directing compound or composition reduces an ability of an insect, for example a bee, to obtain a meal and/or nectar from a plant for at least about 20% or more, about 30% or more, about 40% or more, about 50% or more, about 60% or more, about 75% or more, about 90% or more, about 95% or more, about 98% or more, or about 99% or more for at least about 30 minutes, about 1 hour, about 2 hours, about 3 hours, about 4 hours, about 5 hours, about 8 hours, about 10 hours, about 15 hours, about 20 hours, about 24 hours, about 48 hours, about 72 hours, about 7 days, about two weeks, about one month, about two months, about three months or more or a planting, growing, or harvesting season relative to a compound or composition that does not contain an effective amount of a repelling, controlling, or directing compound or composition described herein. In yet another aspect, a repelling, controlling, or directing compound or composition reduces an ability of an insect to obtain a meal and/or nectar from a plant for at least 95% or more, 96% or more, 97% or more, 98% or more, 99% or more, or 100% for at least about 30 minutes, about 1 hour, about 2 hours, about 3 hours, about 4 hours, about 5 hours, about 8 hours, about 10 hours, about 15 hours, about 20 hours, about 24 hours, about 48 hours, about 72 hours, about 7 days, about two weeks, about one month, about two months, about three months or more or a growing, planting, or harvesting season relative to a compound or composition that does not contain an effective amount of a repelling, controlling, or directing compound or composition described herein.

In an aspect, a repelling, controlling, or directing compound or composition disclosed herein exhibits a larger repelling influence relative to one or more of the following: camphor oil, ajowan oil, camphor powder, or rosemary oil. In yet another aspect, 2-decanone, a repelling compound or composition disclosed herein exhibits a larger repelling effect relative to one or more of the following: camphor oil, ajowan oil, camphor powder, orrosemary oil in a manner that is consistent with the examples and FIGS. 5-6.

In yet another aspect, a repelling, controlling, or directing compound or composition disclosed herein exhibits a larger repelling, controlling, or directing influence relative to one or more of the following: camphor oil, ajowan oil, camphor powder, or rosemary oil for at least about 30 minutes, about 1 hour, about 2 hours, about 3 hours, about 4 hours, about 5 hours, about 8 hours, about 10 hours, about 15 hours, about 20 hours, about 24 hours, about 48 hours, about 72 hours, about 7 days, about two weeks, about one month, about two months, about three months or more. In another aspect, a repelling, controlling, or directing compound or composition disclosed herein exhibits increased repellency, controlling, or directing efficacy for at least about 20% or more, about 30% or more, about 40% or more, about 50% or more, about 60% or more, about 75% or more, about 90% or more, about 95% or more, about 98% or more, or about 99% or more relative to one or more of the following: camphor oil, ajowan oil, camphor powder, or rosemary oil. In another aspect, a repelling, controlling, or directing compound or composition disclosed herein exhibits increased repellency, controlling, or directing efficacy for at least about 20% or more, about 30% or more, about 40% or more, about 50% or more, about 60% or more, about 75% or more, about 90% or more, about 95% or more, about 98% or more, or about 99% or more for at least about 30 minutes, about 1 hour, about 2 hours, about 3 hours, about 4 hours, about 5 hours, about 8 hours, about 10 hours, about 15 hours, about 20 hours, about 24 hours, about 48 hours, about 72 hours, about 7 days, about two weeks, about one month, about two months, about three months or more relative to one or more of the following: camphor oil, ajowan oil, camphor powder, or rosemary oil. In yet another aspect, a repelling, controlling, or directing compound or composition reduces an ability of an insect, for example a bee, to obtain a meal and/or nectar from a plant for at least 95% or more, 96% or more, 97% or more, 98% or more, 99% or more, or 100% for at about 30 minutes, about 1 hour, about 2 hours, about 3 hours, about 4 hours, about 5 hours, about 8 hours, about 10 hours, about 15 hours, about 20 hours, about 24 hours, about 48 hours, about 72 hours, about 7 days, about two weeks, about one month, about two months, about three months or more relative to a compound or composition that does not contain an effective amount of a repelling, controlling, or directing compound or composition described herein.

In an aspect, a repelling, controlling, or directing compound or composition disclosed herein may be more stable (and/or less volatile) than a C₆-C₉ ketone, C₇-C₁₀ ketone, a C₈-C₁₂ ketone, 2-heptanone, 2-undecanone, 2-dodecanone, or 2-trideconone.

In another aspect, a repelling, controlling, or directing compound or composition described herein has a half-life of about 4 hours, about 8 hours, about 12 hours, at least one day, at least three days, at least five days, at least one week, at least two weeks, at least three weeks, at least one month, at least two months, or at least three months. In yet another aspect, a repelling, controlling, or directing compound or composition described herein has a half-life of about 4 hours, about 8 hours, about 12 hours, to one day, about one day to about seven days, about three days to about seven days, about five days to about seven days, about one week to about four weeks, about two weeks to about four weeks, about three weeks to about four weeks, about one month to about four months, about two months to about four months, or about three months to about four months.

### Insects

In an aspect, the insect can be a pollinating insect. In another aspect, the insect is a repelled, controlled, or directed non-pollinating insect.

In another aspect, the insect can be an insect capable of being influenced by the presence of a pesticide, fungicide, herbicidal, or insecticide. In another aspect, the insect can be an insect capable of being influenced by the presence of a pesticide, fungicide, herbicidal, or insecticide dust.

In an aspect, the insect is of the order Hymenoptera. In yet another aspect, the insect is a bee. In another aspect, the bee is a honey bee (Apis). In another aspect, the bee is a European honey bee (Apis mellifera) or Africanized honey bee. Examples of common bees are bumble bees (Bomzbus), small carpenter bees (Ceratina), large carpenter bees (Xylocopa), paper wasps (Polistes), yellow jackets (Vespula), and baldfaced hornets (Vespula). As used herein, the term “honey bee” can refer to any member of the Order Hymenoptera, Family Apidae, and includes, without limitation, Apis andreniformis, Apis cerana, Apis dorsata, Apis florae, Apis mellifera, Apis koschevnikovi, Apis laboriosa, Apis nigrocincta, Apis rorea, subspecies thereof, and strains, varieties, and hybrids thereof.

In yet another aspect, the insect is a butterfly. Butterflies are insects of the Order Lepidoptera. In an aspect, a butterfly is a true butterfly (superfamily Papilionoidea), a skipper (superfamily Hesperioidea), or a moth-butterflies (superfamily Hedyloidea). Examples of common butterflies are Swallowtails and Birdwings (Family Papilionidae) such as Common Yellow Swallowtail (Papilio machaon), Spicebush Swallowtail (Papilio Troilus), Lime Butterfly (Papilio demoleus), the Ornithoptera genus, the Whites and Yellows (Family Pieridae), such as Small White (Pieris rapae), Green-veined White (Pieris napi), Common Jezebel (Delias eucharis), the Blues and Coppers or Gossamer-Winged Butterflies (Family Lycaenidae) such as Red Pierrot (Talicada nyseus), Metalmark butterflies (Family Riodinidae) such as Duke of Burgundy (Hamearis lucina), Plum Judy, (Abisara echerius), the Brush-footed butterflies (Family Nymphalidae) such as Painted Lady, or Cosmopolitan (Vanessa cardui), Monarch butterfly (Danaus plexippus), Morpho genus, Speckled Wood (Pararge aegeria), Skippers (Family Hesperiidae) such as Mallow Skipper (Carcharodus alceae), and Zabulon Skipper (Poanes zabulon).

In another aspect, an insect described herein is an ant. In yet another aspect, the ant is a carpenter ant, a fire ant, a pharaoh ant, a ghost ant, and a black ant.

The disclosure refers to “insects” for simplicity of discussion, but it is to be understood that the present is not so limited. The present disclosure may be utilized to selectively direct, repel and/or control any organism that responds to the compounds or compositions of the present invention, and to any analogues or similar compounds and/or composition thereof that may be expected to have a similar influence on the insect or other organism. Also, the discussion in many cases hereinafter will refer to an “insect of interest” and, unless otherwise clear from the context of its use elsewhere herein, the phrase will be used to refer to the aspect of the present invention that allows for selective controlling, directing or repelling a particular subset of insects or other organisms. In other words, where the user of the present invention desires to control, direct or repel a subset of organisms such as insects, while not directing, controlling or repelling others, the subset of insects being controlled, directed and/or repelled becomes and is referred to as the “insect(s) of interest.”

In another aspect, a compound or composition described herein selectively repels, directs, controls, or alters the behavior of an insect, for example a bee. In yet another aspect, a compound or composition described herein selectively repels, directs, or controls, or alters the behavior of a honey bee, for example, any member of the Order Hymenoptera, Family Apidae, and includes, without limitation, Apis andreniformis, Apis cerana, Apis dorsata, Apis florae, Apis mellifera, Apis koschevnikovi, Apis laboriosa, Apis nigrocincta, Apis rorea, subspecies thereof, and strains, varieties, and hybrids thereof.

In another aspect, a compound or composition described herein selectively repels, directs, controls, or alters the behavior of one type or subset of insects, for example a bee, while not affecting other insects. For instance, in one embodiment, a repelling, controlling, or directing compound or composition is associated with an insecticidal composition, for example, by a combination of the repelling, controlling, or directing compound or composition together with an insecticidal composition. In another aspect, a repelling, controlling, or directing compound or composition is sequentially applied at the same time, prior to, or after an insecticidal composition to, for example, an area, seed, plant part, or plant. In yet another aspect, an attractant compound or composition is applied to a different area or substance aimed at attracting an insect of interest.

As a non-limiting example, (1) 2-decanone as the repelling, controlling, or directing compound is used to treat field, yard, or structure, (2) clothianidin as the insecticidal compound, and (3) sucrose as the attractant compound or composition are used to treat a field, yard, or structure. As an example, all or a first portion of a field, yard, or structure is treated with (1) 2-decanone and (2) clothianidin, while the remaining section of the field, yard, or structure or a second or more portion of a field, yard, or structure is treated with an attractant compound or composition, such as (3) sucrose. Under such a scenario, an insect that is targeted for repelling, controlling, or directing, such as a honeybee, would be selectively repelled, controlled, or directed by the repelling, controlling, or directing compound, in this case the (1) 2-decanone and (2) clothianidin composition/combination, while being simultaneously attracted or drawn to the attractant compound or composition, in this case (3) sucrose. Such a procedure would allow for the selective repulsion or control of an insect of interest, for example a honeybee, while at the same time allowing for the insecticide, in this case clothianidin, to treat any unwanted insects or pests. As such, the honeybee would be selectively repelled, controlled, or directed away from the (1) 2-decanone and (2) clothianidin composition/combination, drawn to the (3) sucrose, while the infestation of any remaining insects or pests is addressed.

As another non-limiting example, compounds, compositions, and methods described herein can be utilized in the following scenario.

For example, in one embodiment of the present disclosure, a vacuum planter is used to plant corn seed in a large field in a typical farming operation. The corn seed is genetically modified to tolerate a glufosinate-based herbicide, and the corn seed is coated with a clothanidin/bacillus firmus seed treatment (e.g. the PONCHO/VOTIVO seed treatment available from Bayer CropScience LP.) The novel lubricant of the present invention is added to a seed hopper on the vacuum planter by scooping it into the seed hopper in a powder form, to provide fluency and lubricity for the corn seeds during the planting operation, but with the desirably reduced dusting associated with the novel lubricant. An insect controlling, directing and repelling composition of the Formulas I-IX, (for example 2 decanone in particular), that selectively repels honey bees is provided in a powder form as a separate composition to be incorporated at or about the time and generally in the same manner that the novel lubricant, e.g., via scooping it into the seed hopper. In an optional embodiment of the present invention, the corn seeds are also coated with an insect controlling, directing and repelling compound at or about the time they are treated with the PONCHO/VOTIVO seed treatment. Also, in an optional embodiment of the present invention, the exhaust mechanism of the vacuum planter is fitted with a mechanism that allows for dispersion of the insect controlling, directing and repelling composition into the vacuum planter's exhaust at a variable rate that is selectable by the operator of the vacuum planter. Also, optionally in this embodiment of the present invention, an adjoining field containing wild flowers is treated with an attractant that operates to attract honey bees to the adjoining field.

When these embodiments of the disclosure are employed, including those that are optional, several benefits are apparent. As a starting point, dusting is reduced or eliminated with the novel lubricant. To the extent any dusting is not eliminated and develops from the corn seeds abrading against each other during planting, with the repellent composition present on the seeds, it will be abraded to and will be included in any dust that is formed and exhausted from the planter. And should more repellent composition be required or desired, the operator of the planter will selectively introduce additional repellent composition into the exhaust stream when and where it is needed.

The result is that honey bees are selectively repelled from the field where planting occurs, and are simultaneously drawn by the attractant to the neighboring field containing the wild flowers. Because the repellant composition is selective for honey bees, the PONCHO/VOTIVO seed treatment remains effective to control other insects and nematodes in the manner described on its label instructions.

### Compositions

In an aspect, the amount of a repelling, controlling, or directing compound or composition described herein can be an amount that is effective (“effective amount”) to repel, control, or direct the movement of an insect of interest. In another aspect, the amount of a repelling, controlling, or directing compound or composition described herein can be an amount that is effective (“effective amount”) to reduce or mitigate the influence of a substance that is harmful to an insect of interest.

In another aspect, a composition comprises a repelling, controlling, or directing compound or composition in at least about 0.01%, at least about 0.025%, at least about 0.05%, at least about 0.1%, at least about 0.25%, at least about 0.5%, at least about 1%, at least about 2% at least about 2.5%, at least about 5%, at least about 7.5%, at least about 10%, at least about 25%, or at least about 50%, by weight of a composition. In yet another aspect, a composition comprises a repelling, controlling, or directing compound or composition is no more than about 0.01%, no more than about 0.025%, no more than about 0.05%, no more than about 0.1%, no more than about 0.25%, no more than about 0.5%, no more than about 1%, no more than about 2.0%, no more than about 2.5%, no more than about 5%, no more than about 7.5%, no more than about 10%, no more than about 25%, no more than about 50%, by weight of a composition.

In another aspect, a compound or composition described herein comprises a repelling, controlling, or directing compound or composition at 0.001% to about 0.1%, about 0.025%, about 0.0025% to about 0.25%, about 0.1% to about 1%, about 0.1% to about 2.5%, about 0.5% to about 2.5%, about 1% to about 2%, about 1% to about 3%, about 1% to about 5%, about 1% to about 10%, about 2% to about 10%, about 5% to about 10%, about 5% to about 20%, about 10% to about 25%, about 10% to about 50%, about 25% to about 50%, or about 20% to about 80%, and about 95% or more by weight of a composition.

In another aspect, a composition described herein comprises an insecticide, herbicide, fungicide, miticide, or other compound described herein in at least about 0.01%, at least about 0.025%, at least about 0.05%, at least about 0.1%, at least about 0.25%, at least about 0.5%, at least about 1%, at least about 2% at least about 2.5%, at least about 5%, at least about 7.5%, at least about 10%, at least about 25%, or at least about 50%, by weight of a composition. In yet another aspect, a composition comprises a repelling, controlling, or directing compound or composition in no more than about 0.01%, no more than about 0.025%, no more than about 0.05%, no more than about 0.1%, no more than about 0.25%, no more than about 0.5%, no more than about 1%, no more than about 2.0%, no more than about 2.5%, no more than about 5%, no more than about 7.5%, no more than about 10%, no more than about 25%, no more than about 50%, by weight of a composition.

In yet another aspect, a composition described herein comprises a insecticide, herbicide, fungicide, miticide, or other compound described herein at 0.001% to about 0.1%, about 0.025%, about 0.0025% to about 0.25%, about 0.1% to about 1%, about 0.1% to about 2.5%, about 0.5% to about 2.5%, about 1% to about 2%, about 1% to about 3%, about 1% to about 5%, about 1% to about 10%, about 2% to about 10%, about 5% to about 10%, about 5% to about 20%, about 10% to about 25%, about 10% to about 50%, about 25% to about 50%, or about 20% to about 80%, and about 95% or more by weight of a composition.

In an aspect, a repelling, controlling, or directing compound or composition described herein can be used in conjunction with an insecticidal, herbicidal and/or fungicidal active agent. In an aspect, the disclosure provides for a composition further including one or more of the following:

(a) acetylcholine esterase inhibitor, for example, carbamate and organophosphates;

(b) a GABA-gated chloride channel antagonist, for example, cyclodiene organochlorine, phenylpyrazole (Fiproles), ethiprole, and fipronil;

(c) sodium channel modulator, for example, methoxychlor and pyrethroids;

(d) nicotinic acetylcholine receptor agonists/antagonists, for example, neonicotinoid, nicotine, nensultap, cartap hydrochloride, and nereistoxin analogues;

(e) nicotinic acetylcholine receptor agonists (allosteric), for example, a spinosyns or spinosad; and

(f) chloride channel activators, for example, avermectin, abamectin, emamectin benzoate, milbemycins, and milbemectin.

In an aspect, an active agent is selected from the group consisting of acetamiprid, clothianidin, dinotefuran, imidacloprid, nitenpyram, thiacloprid, thiamethoxam, ethiprole, fipronil, imidacloprid, spiromesifen, beta-cyfluthrin, spirodiclofen, flubendiamide, thiodicarb, spirotetramat, Poncho, Gaucho, Votivo, Votivo with an additional insecticide, Nipsit INSIDE® (Valent), Platinum® (Syngenta), Admire® Pro (Bayer CropScience), Cruiser (Syngenta), Gaucho (Bayer CropScience), Leverage® (Bayer CropScience), Actara (Syngenta), Venom (Valent), Provado® (Bayer CropScience), Movento® (Bayer CropScience), Larvin® (Bayer CropScience), Belt® (Bayer CropScience), Sepresto® (Bayer CropScience), Leverage 360® (Bayer CropScience), Envidor® (Bayer CropScience), Baythroid® XL (Bayer CropScience), Oberon® (Bayer CropScience), Calypso (Bayer CropScience), Alias (Mana), Pasada (Mana), Couraze (Cheminova), Assail® (DuPont), Poncho®/VOTiVO™ (Bayer CropScience), Poncho® 1250+VOTiVO™ (Pioneer), Poncho® Beta (Bayer CropScience), Poncho® 600 (Bayer CropScience), Gaucho® 600 (Bayer CropScience), Gaucho®-XT (Bayer CropScience), Aeris® (Bayer CropScience), Prosper®FX (Bayer CropScience), Prosper® Evergol (Bayer CropScience), and/or Requiem® (Agroquest).

In another aspect, the disclosure provides for a composition comprising, consisting of, or consisting essentially of a repelling, controlling, or directing compound or composition described herein and an insecticidal, herbicidal and/or fungicidal treating agent. In yet another aspect, the disclosure provides for a composition comprising, consisting of, or consisting essentially of a repelling, controlling, or directing compound or composition described herein and an insecticidal, herbicidal and/or fungicidal treating agent, wherein the composition does not exhibit a reduction of insecticidal, herbicidal and/or fungicidal as the result of the addition of a repelling, controlling, or directing compound or composition described herein.

In an aspect, the disclosure provides for a composition comprising, consisting of, or consisting essentially of (1) a repelling, controlling, or directing compound or composition described herein together with an (2) insecticidal, herbicidal and/or fungicidal treating agent, wherein the combination of (1) a repelling, controlling, or directing compound or composition described herein and (2) insecticidal, herbicidal and/or fungicidal treating agent does not exhibit a reduction in the efficacy of the (2) insecticidal, herbicidal and/or fungicidal treating agent as the result of the addition of (1) a repelling, controlling, or directing compound or composition to (2) insecticidal, herbicidal and/or fungicidal treating agent composition described herein.

In yet another aspect, the disclosure provides for a composition comprising, consisting of, or consisting essentially of 2-decanone and imidacloprid, wherein the 2-decanone and imidacloprid does not exhibit a reduction in the efficacy of the imidacloprid as the result of the addition of 2-decanone to an imidacloprid-based composition described herein. In yet another aspect, the disclosure provides for a composition comprising, consisting of, or consisting essentially of 2-decanone and clothianidin, wherein the 2-decanone and clothianidin does not exhibit a reduction in the efficacy of the clothianidin as the result of the addition of 2-decanone to an clothianidin-based composition described herein.

In another aspect, a repelling, controlling, or directing compound or composition described herein is formulated with insecticidal, herbicidal, fungicide, insect regulator, plant growth regulator, plant growth regulator for crop protection, insect growth regulator, and pest control agents, such as household pest control agents.

In an aspect, the disclosure provides for a composition comprising, consisting of, or consisting essentially of one or more repelling, controlling, or directing compounds or compositions disclosed herein. In another aspect, the disclosure provides for a composition comprising, consisting of, or consisting essentially of a single repelling, controlling, or directing compound or composition disclosed herein. In yet another aspect, the disclosure provides for a composition comprising, consisting of, or consisting essentially of two, three, four, or five or more repelling, controlling, or directing compounds or compositions. In another aspect, the disclosure provides for a composition comprising, consisting of, or consisting essentially of no more than two, no more than three, no more than four, or no more than five or more repelling, controlling, or directing compounds or compositions.

In an aspect, a compound or composition described herein is formulated as a foliar composition, a foliar spray, solutions, emulsions, suspension, coating formulation, non-pesticidal or pesticidal coating formulation, encapsulated formulation, solid, liquid, fertilizer, paste, granule, powder, suspension, or suspension concentrate. In another aspect, a compound or composition described herein may be employed alone or in solid, dispersant, or liquid formulation. In yet another aspect, a compound or composition described herein is formulated as a tank-mix product.

In another aspect, a compound or composition described herein can take any of a variety of dosage forms including, without limitation, suspension concentrates, aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspoemulsion concentrates, soluble concentrates, suspensions, wettable powders, soluble powders, dusts and granules, water-soluble granules or tablets, water-soluble powders for the treatment of seed, wettable powders, natural products and synthetic substances impregnated with a compound or composition described herein, a net impregnated with a compound or composition described herein, and also microencapsulations in polymeric substances and in coating materials for seed, and also ULV cold-fogging and warm-fogging formulations.

In another aspect, a seed is coated, encapsulated or otherwise covered with one or more repelling, controlling, or directing compounds or compositions described herein. In yet another aspect, a seed is coated, encapsulated or otherwise covered with one or more repelling, controlling, or directing compounds and one or more insecticides, pesticides, fungicides, fertilizers of a micronutrient or macronutrient nature, herbicides, feeding inhibitors, insect molting, insect mating, insect maturation inhibitors, nematocides, nutritional or horticultural supplements, or larvicides. In another aspect, a compound or composition described herein is formulated to repel, control, or direct an insect, for example a bee, from a seed. In another aspect, a compound or composition described herein is formulated to repel an insect, for example a bee, from a seed and therefore from a field, yard, pot, area, bush, tree, or body of water onto which the seeds are intentionally or unintentionally present as well as provide an additional beneficial or otherwise useful effect.

In another aspect, a compound or composition disclosed herein may optionally include one or more additional compounds providing an additional beneficial or otherwise useful effect. Such compounds include, without limitation, an adhesive, a solvent, a surfactant, a wetting agent, an emulsifying agent, a carrier, adjuvant, a diluent, a dispersing agent an insecticide, a pesticide, a fungicide, a fertilizer of a micronutrient or macronutrient nature, a herbicide, a feeding inhibitor, an insect molting inhibitor, an insect mating inhibitor, an insect maturation inhibitor, a nematocide, a nutritional or horticultural supplement, or any combination thereof. In an aspect, a composition described herein is odor free. In another aspect, the surfactant is Genapol, for example Genapol X-080.

In another aspect, compounds or compositions described herein can be combined with a fertilizer. Examples of fertilizers capable of being used with the compositions and methods described herein include, for example, Urea, Ammonium Nitrate, Ammonium Sulfate, Calcium Nitrate, Diammonium Phosphate, Monoammonium phosphate, Triple Super Phosphate, Potassium Nitrate, Potassium nitrate, nitrate of potash, Potassium Chloride, muriate of potash, di and mono potassiumaiusm salts of phosphite/phosphonate.

In another aspect, the disclosure provides for a fertilizer composition combined with at least one repelling, controlling, or directing compound or composition from Formula I-IX or compounds 1-33 in Table 1.

The disclosure also provides for bait composition comprising a compound or composition described herein. In another aspect, the disclosure provides for bait composition comprising a repelling, controlling, or directing compound or composition described herein. The bait composition comprising a repelling, controlling, or directing compound or composition described herein and may be used in any of the methods described herein and may optionally include another active ingredient, such as an insecticide, herbicide, or pesticide.

In an aspect, an insect repelling, controlling, or directing compound or composition is combined with a compound or composition that alters the olfactory senses, sight, chemosensory senses, or other physical characteristics of an insect. In another aspect, an insect repelling compound or composition described herein can be combined with a compound or composition that alters the behavior of an insect by color, taste, or additional feature that has the ability to influence the senses of an insect.

In an aspect, a composition or method described herein includes an inorganic lubricant composition. In another aspect, a composition or method described herein does not include an inorganic lubricant composition. Inorganic compounds, for example talc and graphite, encompass compounds such as carbides, carbonates, simple oxides of carbon, cyanides, and allotropes of carbon.

In an aspect, a repelling, controlling, or directing compound or composition described herein is combined with a talc and/or graphite. In another aspect, a repelling, controlling, or directing compound or composition described herein is combined with talc and/or graphite and an active agent compound or composition, for example, an insecticide, pesticide, fungicide, or herbicide. In another aspect, (1) the talc and/or graphite, (2) repelling, controlling, or directing compound or composition, and (3) an active agent are added to a hopper box or planter together, separately, or combinations thereof. In another aspect, seed is added to the hopper or planter with the composition combination. In yet another aspect, seed pre-treated with an active agent composition is added to the hopper and/or planter and a talc and/or graphite composition is added together with a repelling, controlling, or directing compound or composition described herein.

In an aspect, a composition or method described herein does not include talc. In another aspect, a composition or method described herein does not include graphite or graphite blends. In yet another aspect, a composition or method described herein does not include blends of graphite and/or talc. In another aspect, a composition or method described herein contains trace amount of talc or graphite. In another aspect, a composition or method described herein contains less than about 5%, less than about 10%, less than about 20%, less than about 20%, less than about 30%, less than about 40%, or less than about 50% by weight of talc, graphite, or a combination of talc or graphite.

In an aspect, a repelling, controlling, or directing compound described herein is formulated as follows:

TABLE 2
Repelling, Controlling, or Directing Compound Alone

| | | | | |
|---|---|---|---|---|
| 1 | EC Formulation | Compound | Surfactant | |
| 2 | EC Formulation | Compound | Surfactant | Water |

Compound + Solid Carrier

| | | | | | | | |
|---|---|---|---|---|---|---|---|
| 3 | WP Formulation | Compound | Attagel/Silica | Surfactant/ | Dispersant | | |
| | | | | wetter | | | |
| 4 | SC Formulation | Compound | Attagel/Silica | Surfactant/ | Dispersant | Water | |
| | | | | wetter | | | |
| 5 | SC Formulation | Compound | Attagel/Silica | Surfactant/ | Dispersant | Water | Salt |
| | | | | wetter | | | |

Compound + Solid Carrier + Wax (Encapsulated or Controlled Release)

| | | | | | | | |
|---|---|---|---|---|---|---|---|
| 6 | WP Formulation | Compound | Attagel/Silica/ | Surfactant/ | Dispersant | | |
| | | | Wax | wetter | | | |
| 7 | SC Formulation | Compound | Attagel/Silica/ | Surfactant/ | Dispersant | Water | |
| | | | Wax | Wetter | | | |
| 8 | SC Formulation | Compound | Attagel/Silica/ | Surfactant/ | Dispersant | Water | Salt |
| | | | Wax | wetter | | | |
| 9 | WP Formulation | Compound/Wax | Attagel/Silica | Surfactant/ | Dispersant | | |
| | | | | wetter | | | |
| 10 | SC Formulation | Compound/Wax | Attagel/Silica | Surfactant/ | Dispersant | Water | |
| | | | | Wetter | | | |
| 11 | SC Formulation | Compound/Wax | Attagel/Silica | Surfactant/ | Dispersant | Water | Salt |
| | | | | wetter | | | |

EC—Emulsion concentrate; WP—Wettable Powder; SC—Suspension Concentrate; “Compound” refers to repelling, controlling, or directing compound

### Controlled Release, Extended Release, Rapid Release and Multi-Coating Release Formulations

In another aspect, a compound or composition described herein can be formulated in a controlled-release, extended-release, rapid-release formulation or combinations thereof. In another aspect, a compound or composition described herein can be formulated in a multi-coating or multi-layer formulation. The disclosure also provides for a formulation designed to release a compound or composition disclosed herein over a period of about 5 minutes, about 15 minutes, about 30 minutes, about 1 hour, about 2 hours, about 6 hours, about 12 hours, about 24 hours, about 3 days, about 5 days, about 7 days, about 15 days, about 30 days, about 45 days, about 60 days, about 75 days, or about 90 days in single or multiple release time points. In another aspect, the disclosure also provides for a formulation designed to release a compound or composition disclosed herein over a period of about 30 minutes to about 1 hour, about 1 hour to about 6 hours, about 6 hours to about 12 hours, about 24 hours to 2 days, about 1 to about 7 days, about 7 days to about 15 days, about 10 days to about 30 days, or about 30 days to about 60 days or more.

In an aspect, a rapid-release layer or coating releases a compound immediately, after about 1 minute, after about 5 minutes, after about 15 minutes, after about 30 minutes, after about 1 hour, or after about 2 hours. In another aspect, a controlled release layer or coating releases a compound after about 3 hours, after about 6 hours, after about 12 hours, or after about 18 hours. In another aspect, an extended release or delayed-release layer or coating releases a compound after about 1 day, after about 2 days, after about 3 days, after about 7 days, or after about 14 days or more.

The disclosure also provides for a composition with a coating as follows:
(1) an outside rapid release coating with a first insect repelling, controlling, or directing compound or composition described herein; and
(2) at least one inner extended or controlled release coating with a second insect repelling, controlling, or directing compound or composition described herein.

The disclosure also provides for a composition with a coating as follows:
(1) an outside controlled release coating with a first insect repelling, controlling, or directing compound or composition described herein; and
(2) at least one inner extended or controlled release coating with a second insect repelling, controlling, or directing compound or composition described herein.

The disclosure also provides for a composition with a coating as follows:
(1) an outside rapid release coating with a first insect repelling, controlling, or directing compound or composition described herein;
(2) at least one inner extended or controlled release coating with a second insect repelling, controlling, or directing compound or composition described herein, and
(3) at least one inner extended or controlled release coating with a compound or composition capable of repelling, controlling, or directing an insect pest or predator.

The disclosure also provides for a composition with a coating as follows:
(1) an outside rapid release or controlled release coating with a first insect repelling, controlling, or directing compound or composition described herein; and
(2) at least one inner extended or controlled release coating with a compound or composition capable of repelling, controlling, or directing the insect pests or predators.
   In an aspect, the insect would be attracted and exposed to the rapid release or controlled release repelling, controlling, or directing compound or composition. After exposure to the rapid release or controlled release attractant, the insect, for example a bee, would take a percentage of the compound or composition back to the hive wherein the slow release compound or composition capable of repelling the insect pests or predators. Such a methodology would provide additional protection for the hive thereby promoting the health of insects.

The disclosure also provides for a composition with a coating as follows:
(1) an outside rapid release or controlled release coating with a first insect attractant compound or composition described herein; and
(2) at least one inner slow or controlled release coating with a compound or composition capable of promoting the health of an insect, such as an antibiotic or a nutritional supplement.
   In an aspect, the insect would be attracted and exposed to the rapid release or controlled release attractant compound or composition. After exposure to the rapid release attractant, the insect, for example a bee, would take a percentage of the compound or composition back to the hive wherein the slow release compound or composition capable of promoting the health of an insect, such as an antibiotic or a nutritional supplement, would be released.

In another embodiment, a repelling, controlling, or directing compound or composition disclosed herein can be incorporated into a controlled-release device which dispenses a honey bee repelling, controlling, or directing compound and/or other beneficial compound over time in a regulated or predictable manner. A controlled-release device disclosed herein may be employed by itself or incorporated into another device used to house the controlled-release device.

Formulations that provide for release of a compound or composition, for example, by degradation, light release or release with lack of light, or moisture are also provided for.

### Methods of Repelling, Controlling, or Directing Insects and Reducing Seed Dust

a. Lubricant and/or Wax-Based Compositions

The disclosure also provides for a method of reducing dust released during planting by utilizing a dust reducing composition or lubricity composition together with a repelling, controlling, or directing compound or composition described herein. In an aspect, the disclosure provides for a method of reducing insect exposure to vacuum planter dust released during planting by utilizing a compound or composition described herein. In an aspect, the vacuum planter dust is an insecticidal, pesticidal, or fungicidal dust.

In an aspect, the disclosure provides for a method of repelling, controlling, or directing an insect by applying (1) a repelling, controlling, or directing compound or composition herein to seed in combination with a (2) dust reducing composition described herein. In another aspect, a compound or composition described herein is applied to wet seed. The disclosure also provides for a method of increasing seed lubricity by coating a seed with a dust reducing composition in conjunction with a compound or composition described herein.

The disclosure also provides for a method of adding a dust reducing wax composition together with a compound or composition described herein to a seed. In another aspect, a wax or lubricant compound or composition is added to a pre-treated seed prior planting. In another aspect, a seed is pre-treated by both a dust reducing wax or lubricant composition and a compound or composition described herein prior to planting. In yet another aspect, a seed is pre-treated by both a dust reducing wax composition and a compound or composition described herein in a planter or hopper either manually or with a mechanized system, such as a mechanized metering system. In an aspect, the powder form of a wax is added to seed in a planter.

In an aspect, the dust, insecticidal dust, herbicidal dust, pesticidal dust, or fungicidal dust emission is reduced relative to traditional lubricants, such as talc or graphite. In yet another aspect, a lubricant composition described herein, for example a wax composition, reduces the dust, insecticidal dust, herbicidal dust, pesticidal dust, or fungicidal dust emission from the planter mechanism, such as an air or vacuum planter. In an aspect, the planter mechanism is a John Deere, Case IH, Kinze, AGCO White, Great Plains, or Precision Planting vacuum planter.

In an aspect, the dust reducing composition is a lubricant. In an aspect, a dust reducing wax composition is selected from the group consisting of polyethylene, powdered polyethylene, carnuba, paraffin, polypropylene, an oxidized polyethylene wax, a powdered oxidized polyethylene wax, montan waxes, microcrystalline waxes, Fischer-Tropsch waxes, amide waxes, Ethylene-Acrylic-Acid (EAA) waxes, polyolefin waxes, Ethylene bis stearamide (EBS) waxes, animal waxes (bees wax & lanolin), vegetable waxes (carnauba & candelilla), or slac and scale waxes.

In another aspect, a compound or composition described herein can be applied to a seed, plant part, or plant by the following methods: “on planter,” “fogging,” or in a “Hopper box.” In another aspect, a repelling, controlling, or directing compound described herein can be added to a lubricant or dust reducing compound or composition. In yet another aspect, a repelling, controlling, or directing compound described herein can be incorporated or encapsulated within a seed.

b. Compositions for Reducing Seed Dust and Dispersing an Active Agent on a Seed Surface

In an aspect, the disclosure provides for compositions capable of dispersing an active agent on a seed surface and methods thereof. In yet another aspect, compositions described herein are capable of achieving improved active agent uniformity on a seed surface thereby yielding treated seeds with reduced dust content. In another aspect, the dust reducing compositions provided herein are combined with an insecticide, herbicide, pesticide, and/or fungicide compound or composition and result in a decreased dust profile during planting.

In another aspect, a composition herein reduces coating dust or can be used as a pre-treatment seed additive to reduce seed dust.

In an aspect, a composition described herein includes one or more of the following and combinations thereof:

(a) oil;

(b) wetting agent; and

(c) dispersing agent.

In yet another aspect, a composition described herein includes one or more of the following and combinations thereof:

(a) oil;

(b) wetting agent; and

(c) binder.

In an aspect, a composition described herein includes one or more of the following and combinations thereof:

(a) film forming compound;

(b) binder;

(c) oil;

(d) wetting agent; and

(e) dispersing agent.

In another aspect, the disclosure provides for a composition comprising one or more of the following and combinations thereof:

(a) poly(vinyl alcohol)/poly(vinyl pyrrolidone) (“PVP-PVA”) copolymer;

(b) polyurethane composition or dispersion;

(c) ethoxylated fatty acid;

(d) sorbitan monooleate;

(e) alkyl alcohol with an ethylene oxide/propylene oxide;

(f) ethoxylated oleyl alcohol; and

(g) oil.

In another aspect, the disclosure provides for a composition comprising one or more of the following and combinations thereof:

(a-1) poly(vinyl alcohol)/poly(vinyl pyrrolidone) (“PVP-PVA”) copolymer;

(b-2) polyurethane composition or dispersion;

(c-3) ethoxylated fatty acid;

(d-4) sorbitan monooleate;

(e-5) alkyl alcohol with an ethylene oxide/propylene oxide;

(f-6) ethoxylated oleyl alcohol;

(g-7) mineral oil; and

(h-8) vegetable oil.

In another aspect, the disclosure provides for a dust reducing composition comprising components “a-1” to “h-8” set forth in Table 3 and Table 4. As set forth in Tables 3 and 4, the amount of each respective component (in samples 1-11) is represented in “weight percent.” Each sample exhibits a reduced dust profile relative to a seed sample that is not treated with the components set forth in Tables 3 and 4.

TABLE 3

| Sample | a-1 | b-2 | c-3 | d-4 | e-5 | f-6 | g-7 | h-8 |
|---|---|---|---|---|---|---|---|---|
| 1 | 1-8 | 6-15 | 0 | 2-10 | 2-10 | 2-10 | 0 | 0 |
| 2 | 1-8 | 0 | 2-10 | 2-10 | 2-10 | 0 | 0 | 0 |
| 3 | 0 | 6-15 | 2-10 | 2-10 | 0 | 0 | 0 | 12-25 |
| 4 | 1-8 | 6-15 | 2-10 | 0 | 0 | 0 | 6-15 | 0 |
| 5 | 1-8 | 6-15 | 0 | 0 | 0 | 2-10 | 0 | 12-25 |
| 6 | 1-8 | 0 | 0 | 0 | 2-10 | 0 | 6-15 | 12-25 |
| 7 | 0 | 0 | 0 | 2-10 | 0 | 2-10 | 6-15 | 0 |
| 8 | 0 | 0 | 2-10 | 0 | 2-10 | 2-10 | 0 | 12-25 |
| 9 | 0 | 6-15 | 0 | 2-10 | 2-10 | 0 | 6-15 | 12-25 |
| 10 | 1-8 | 0 | 2-10 | 2-10 | 0 | 2-10 | 6-15 | 12-25 |
| 11 | 0 | 6-15 | 2-10 | 0 | 2-10 | 2-10 | 6-15 | 0 |

TABLE 4

| Sample | a-1 | b-2 | c-3 | d-4 | e-5 | f-6 | g-7 | h-8 |
|---|---|---|---|---|---|---|---|---|
| 1 | 1-10 | 5-25 | 0 | 2-15 | 2-15 | 2-15 | 0 | 0 |
| 2 | 1-10 | 0 | 2-15 | 2-15 | 2-15 | 0 | 0 | 0 |
| 3 | 0 | 5-25 | 2-15 | 2-15 | 0 | 0 | 0 | 5-40 |
| 4 | 1-10 | 5-25 | 2-15 | 0 | 0 | 0 | 1-20 | 0 |
| 5 | 1-10 | 5-25 | 0 | 0 | 0 | 2-15 | 0 | 5-40 |
| 6 | 1-10 | 0 | 0 | 0 | 2-15 | 0 | 1-20 | 5-40 |
| 7 | 0 | 0 | 0 | 2-15 | 0 | 2-15 | 1-20 | 0 |
| 8 | 0 | 0 | 2-15 | 0 | 2-15 | 2-15 | 0 | 5-40 |
| 9 | 0 | 5-25 | 0 | 2-15 | 2-15 | 0 | 1-20 | 5-40 |
| 10 | 1-10 | 0 | 2-15 | 2-15 | 0 | 2-15 | 1-20 | 5-40 |
| 11 | 0 | 5-25 | 2-15 | 0 | 2-15 | 2-15 | 1-20 | 0 |

In an aspect, a film forming compound is a compound that forms a solid layer on a seed surface. In another aspect, a film forming compound is a compound that forms a solid layer when slurry dries on a seed surface. Without being limited, a film forming compound is selected from the group consisting of polyurethane compound or composition, a polyurethane dispersion, an anionic aliphatic polyester-polyurethane dispersion, a water-soluble polymer, a polyvinylpyrrolidone (PVP polymer), Impranil® DLN 50 (Bayer), Impranil® DLN W 50 (Bayer), Luvitec® VA 64 (BASF), and Luvitec® line of products

In an aspect, a binder is a compound or composition that binds particles on seed surface. In another aspect, a binder is a compound or composition that physically or chemically binds solid particles on seed surface. Without being limited, a binder is an adhesion agent, acrylic polymer, vinyl acetate, or a styrene-butadyne polymeric latex compound.

In an aspect, an oil is selected from the group consisting of, for example, mineral oil, mineral processing oil, vegetable oil, natural oil, synthetic oil, refined vegetable oil, plant oil, linseed oil, and Tufflo® 100 (Calumet).

In an aspect, a wetting agent is a material capable of making a hydrophobic seed surface more hydrophilic. In another aspect, a wetting agent is a material, for example a surfactants, capable of making a hydrophobic seed surface more hydrophilic. Without being limited, a wetting agent is selected from the group consisting of a fatty alcohol ethoxylate, polysiloxane, sorbitan monooleate, polyoxyethylene sorbitan monooleate Polyoxyethylene sorbitan monooleate, ethoxylated oleyl alcohol, Ninex® MT-615 (Stepan), Genapol® O-100 (Clariant), or Tween® 80.

In an aspect, a dispersing agent is a material capable of keeping suspended particles from coagulating or aggregating. In another aspect, a dispersing agent creates a barrier between active ingredients, without being limited, a dispersing agent is selected from the group consisting of naphthalene, alkyl alcohol with an ethylene oxide/propylene oxide (“EO-PO”)n chain, butyl capped EO-PO copolymer, and Antarox® B/848 (Rhodia).

In another aspect, the dust reducing composition described herein can include one or more of the following and combinations thereof: Luvitec® VA 64; Impranil® DLN 50; Antarox® B/848; Ninex® MT-615; Tween® 80; Genapol® O-100; Tufflo® 100; and Linseed oil.

In an aspect, the methods and compositions described herein reduce dust, insecticidal dust emissions, pesticidal dust emissions, herbicidal dust emissions, or fungicidal dust emissions by about 5% to about 20%, about 20% to about 60%, about 40% to about 70%, about 50% to about 90%, about 60% to about 80%, about 65% to about 95%, about 80% to about 95%, or about 5%, about 15%, about 25%, about 40%, about 50%, about 60%, about 70%, about 80%, about 90%, or about 95%, or about 5% or more, about 15% or more, about 25% or more, about 40% or more, about 50% or more, about 60% or more, about 70% or more, about 80% or more, about 90% or more, or about 95% or more. In yet another aspect, the dust emissions, insecticidal dust emissions, pesticidal dust emissions, or fungicidal dust emissions is reduced relative to traditional lubricants, such as talc or graphite.

In an aspect, a seed dust reducing compound or composition described herein is applied to a seed at a rate of about 0.1-5.0 oz/cwt (ounces/hundredweight), about 0.5-4.0 oz/cwt, about 1.0-3.5 oz/cwt, about 1.5-3.0 oz/cwt, about 2.0-3.0 oz/cwt, about 2.0-2.5 oz/cwt, or about 0.2 oz/cwt, about 0.5 oz/cwt, about 0.75 oz/cwt, about 1.0 oz/cwt, about 1.5 oz/cwt, about 2.0 oz/cwt, about 2.5 oz/cwt, about 3.0 oz/cwt, about 3.5 oz/cwt, about 4.0 oz/cwt, about 4.5 oz/cwt, about 5.0 oz/cwt, or about 0.2 oz/cwt or more, about 0.5 oz/cwt or more, about 0.75 oz/cwt or more, about 1.0 oz/cwt or more, about 1.5 oz/cwt or more, about 2.0 oz/cwt or more, about 2.5 oz/cwt or more, about 3.0 oz/cwt or more, about 3.5 oz/cwt or more, about 4.0 oz/cwt or more, about 4.5 oz/cwt or more, or about 5.0 oz/cwt or more. In yet another aspect, a composition described herein is applied to a seed in a manner sufficient to convey the desired property.

### Mite Repelling or Killing Compound or Composition

In an aspect, a composition described herein can include a compound capable of controlling or killing a mite. In an aspect, a compound capable of controlling or killing a mite is selected from the group consisting of 1-arylimidazoles, 1-aryl pyrroles, and 1-arylpyrazoles.

In another aspect, a compound capable of controlling or killing a mite is selected from the group consisting of Formulas X-XII:

[chemical structure]

wherein,
X is halogen, Cl, F, Br, or I;
A₁, A₂, and A₃ are individually selected from halogen, Cl, F, Br, I, alkyl, or haloalkyl;
Z is H, CN, halogen, or alkylcarbonyl,
n is 0, 1, or 2, and
Y is alkyl, methyl, haloalkyl, perhaloalkyl, polyhaloalkyl, CF2Cl, CF3, or CCl2F.

In another aspect, compounds of Formulas X-XII can be used together with a compound or composition described herein in the methodology described herein.

Composition or Support Treated with a Compound or Composition Described Herein

In an aspect, the disclosure provides for a support or carrier material combined with a compound or composition described herein. In another aspect, the support material can be coated or impregnated with a compound or composition described herein. An insecticide, herbicide, fungicide, or miticide can also be added to the support material coated or impregnated with a compound or composition described herein. Examples of support materials capable of being used with a compound or composition described herein include an absorbent material, wood, cardboard, corrugated cardboard, cotton, wallpaper, paper, plastic, a plastic tube, and metal. Support materials with a low heat transfer rate may also be suitable.

### Methods of Synthesizing Ketones Described Herein

Ketones described herein can be synthesized or prepared using various methods, transformations, and reactions. In an aspect, a ketone prepared herein is produced from its corresponding alcohol by oxidation of alcohols to ketones in the presence of catalyst. The alkene oxidation can be carried out under catalytic conditions. In an aspect, the ketones are extracted or isolated from a natural source.

In an aspect, a ketone described herein can be prepared or manufactured using the Wacker process or the Hoechst-Wacker process by the oxidation of alkenes to ketones.

The Wacker-Tsuji oxidation is the laboratory scale version of the above reaction (wacker process), for example the conversion of 1-decene to 2-decanone with palladium(II) chloride and copper(I) chloride in a water/dimethylformamide solvent mixture in the presence of air as follows in Formula I:

[chemical structure]

In another aspect, the Weinreb ketone synthesis can be applied to synthesize or prepare ketones described herein. The reaction involves two subsequent reactions that converts an acid chloride into an N,O dimethylhydroxyamide, (a Weinreb amide) and subsequent treatment with an organometallic reagent such as a Grignard reagent or organolithium reagent. The reaction mechanism is shown below.

[chemical structure]

In an aspect the disclosure also provides for a method of producing a ketones described herein as follows:

1) By hydrolysis of gem-dihalides;
2) By hydrolysis of vinyl ethers, acetals, and ortho esters;
3) By hydrolysis of enol esters;
4) By alkylation using carbanion with alkyl halides;
5) By reaction of acyl halides with organometallic compounds such as Grignard reagents;
6) By Ruzicka cyclization to form cyclic ketones from dicarboxylic acid;
7) By utilizing Friedel-Crafts acylation to synthesize aryl ketone;
8) By acylation with nitriles (Hoesch reaction or Houben-hoesch reaction);
9) By Fries rearrangement starting from aryl ester in the presence of acid such as Lewis acid, e.g. ALCL3;
10) By Using Stork enamine reaction;
11) By decomposition of tertiary hypochlorites;
12) By hydration of alkynes;
13) By hydrolysis of imime (C═N double bond);
14) By hydrolysis aliphatic nitro compounds;
15) By addition of Grignard reagents to nitriles;
16) By pinacol rearrangement;
17) By rearrangement of vinyl ether; and
18) By ozonolysis of olefin.

In another aspect, a ketone described herein can be converted to a corresponding oxime by any known synthesis method. In another aspect, a ketone described herein can be used as an insect repellent and the corresponding oxime can be used as an insect attractant. In yet another aspect, the disclosure provides for a method of producing a ketone to be used as an insect repellent and converting said ketone to an oxime which can be used as an insect attractant.

In yet another aspect, the disclosure provides for a one step method of producing both an insect attractant (oxime) and insect repellent (ketone) by converting a (1) ketone to a corresponding (2) oxime by a one step method producing a ketone to be used as an insect repellent. In an aspect, the ketone repellent and oxime attractant can be used to repel or attract the same or different insect during the same or different methods.

### Kit

In another aspect, the disclosure provides for a kit comprising, consisting essentially of, or consisting of any of the compounds or compositions disclosed herein. In an aspect, the kit includes any of the combination of compounds or compositions described in Examples 1-5, Tables 1-8, or FIGS. 1-6. In another aspect, the kit provides for the compositions described in Examples 1-5, Tables 1-8, or FIGS. 1-6, applied in a manner that is consistent with the methodology of these examples and figures. In another aspect, the kit provides instructions or guidance regarding the use of the compositions or methods described herein.

In an aspect, the kit includes instructions describing the methodology described herein. In another aspect, the kit includes instructions describing the methodology set forth in any of Examples 1-5, Tables 1-8, or FIGS. 1-6. In an aspect, the instructions are included with the kit, separate from the kit, in the kit, or are included on the kit packaging.

In another aspect, a repelling, controlling, or directing compound or composition disclosed herein is incorporated into a device or support. In another aspect, a device can include a device designed to house and/or shelter a repelling, controlling, or directing compound or composition disclosed herein. In yet another aspect, a device disclosed herein may be a container, holder or other solid support onto or into which a repelling, controlling, or directing compound or composition disclosed herein. A device disclosed herein may be made from any biological or synthetic material, including, without limitation, paper, filter paper, wood, cork, cotton, plastic, polymer, metal, or glass.

In another aspect, the kit can contain a single-use disposable detection device, bait, support material, or trap. The kit may also contain a reusable multi-use detection device, bait, support material, or trap.

In another aspect, the kit may include a supplement to the detection device, bait, support material, or trap. For example, the supplemental kit may contain an additional bait composition or other supplement to the to the detection device, bait, support material, or trap. In one aspect, the supplemental kit is packaged separate from the detection device, bait, support material, or trap. In another aspect, the supplemental kit is packaged together with the detection device, bait, support material, or trap.

The following examples serve to illustrate certain aspects of the disclosure and are not intended to limit the disclosure.

### EXAMPLES

### Example 1

Example 1 sets forth the feeding station arrangement for the honeybee repulsion experiments described herein.

FIG. 1 describes the feeding station arrangement (A and B) for the honeybee repulsion experiments described herein. As set forth in FIG. 1, panel (A) sets forth the bee cage positions on the left portion of panel (A) with the randomized feeding station positions on the right portion of panel (A). Panel (B) sets forth an alignment of the randomized feeding station positions with a distance of two meters between feeding stations. A total of eight feeding stations were evaluated at a ten meter distance in front of the respective bee hives. The feeding stations were placed two meters apart from one another.

Honeybees were trained to deep feeders (eight positions), each containing a 50% sucrose solution for one day. After the honeybees were trained to each feeder, the 50% sucrose feeder at randomized positions 1-8 was replaced with a shallow feeder containing a combination of repelling compounds and a 50% sucrose solution according to Table 5. In accordance with FIGS. 5 and 6, 2% by weight of Camphor oil (T4), Ajowan oil (T5), Camphor powder (T6), Rosemary oil (T7), and 2-Decanone (T8) in combination with a 50% sucrose treatment were added to feeders on day two. Honeybees in randomized position 8 (2-Decanone) exhibited repellency at 24 hours.

### Example 2

Example 2 describes the effectiveness of various active agents in repelling honeybees.

Table 5 describes active agents evaluated for bee repulsion and their randomized feeding station positions. As described in Table 5, T1 (control), T2 (control), T3 (control), T4 (Camphor oil), T5 (Ajowan oil), T6 (Camphor powder), T7 (Rosemary oil), and T8 (2-Decanone).

TABLE 5

| | | Randomized |
|---|---|---|
| | | position |
| Number | | (feeding station |
| Code | Treatment | number) |
| 1 | C (untreated 50% sucrose) | 6 |
| 2 | C (untreated 50% sucrose) | 7 |
| 3 | C (untreated 50% sucrose) | 1 |
| 4 | Camphor oil 2.18 g/100.4 g with 50% sucrose | 4 |
| 5 | Ajowan oil 3.25 g/101.1 g with 50% sucrose | 2 |
| 6 | Camphor powder diluted to 100 fluid g with | 5 |
| | 50% sucrose | |
| 7 | Rosemary oil 2.09 g/114 g 1 g with 50% | 3 |
| | sucrose | |
| 8 | 2-Decanone 8.6 g/111.83 g 1 g with 50% | 8 |
| | sucrose | |

FIG. 5 evaluates the number of bees visiting a respective feed station over a time interval. FIG. 6 sets forth the mean number of honeybees visiting feeding station over a period of four hours. 2-decanone was highly repellent for the full 4 hour assessment period and was still repellent after 24 hours. Rosemary oil exhibited initial repellency, but this repellency was not fully maintained for the full 4 hour assessment period

### Example 3

Example 3 sets forth the stability of Poncho with an insect repellent, Eugenol.

Table 6 describes a stability test with a combination of Eugenol and Poncho evaluated at room temperature, 40° C., and 54° C. at zero time, 3 days, and 7 days as confirmed by high performance liquid chromatography (HPLC). As described in Table 6, the content of clothianidin, which is the active agent in Poncho, exhibited chemical stability when combined with an insect and bee repellent Eugenol for up to 54° C. for seven days.

TABLE 6
Clothianidin content

| | zero | after | after |
|---|---|---|---|
| | time | 3 days | 7 days |
| Room Temperature | | | |
| Poncho 600 only | 46.30% | 43.88% | 45.19% |
| Poncho 600 + Eugenol at .0053 | 46.25% | 44.48% | 46.02% |
| mg/ml | | | |
| Poncho 600 + Eugenol at .0372 | 43.36% | 35.90% | 41.72% |
| mg/ml | | | |
| 40° C. | | | |
| Poncho 600 only | 46.30% | 44.60% | 44.93% |
| Poncho 600 + Eugenol at .0065 | 46.25% | 44.10% | 44.48% |
| mg/ml | | | |
| Poncho 600 + Eugenol at .0086 | 43.36% | 40.01% | 40.23% |
| mg/ml | | | |
| 54° C. | | | |
| Poncho 600 only | 46.30% | 45.16% | 45.19% |
| Poncho 600 + Eugenol at .0029 | 46.25% | 43.80% | 43.41% |
| mg/ml | | | |
| Poncho 600 + Eugenol at .0203 | 43.36% | 42.53% | 40.65% |
| mg/ml | | | |

### Example 4

Example 4 sets forth the stability of Poncho with an insect repellent, α-terpineol.

Table 7 describes a stability test with a combination of α-terpineol and Poncho 600 evaluated at room temperature, 40° C., and 54° C. at zero time, 2 days, and 8 days as confined by HPLC. As described in Table 7, the content of clothianidin, which is the active agent in Poncho, exhibited chemical stability when combined with an insect and bee repellent alpha-terpineol for up to 54° C. for eight days.

TABLE 7
Clothianidin content

| | zero | after | after |
|---|---|---|---|
| | time | 2 days | 8 days |
| Room Temperature | | | |
| Poncho 600 only | 45.31% | 46.51% | 55.33% |
| Poncho 600 + α-terpineol at .4173 | 45.45% | 44.62% | 53.62% |
| mg/ml | | | |
| Poncho 600 + α-terpineol at .3600 | 45.29% | 45.32% | 45.07% |
| mg/ml | | | |
| 40° C. | | | |
| Poncho 600 + α-terpineol at .3659 | 45.45% | 44.97% | 45.27% |
| mg/ml | | | |
| Poncho 600 + α-terpineol at ..3981 | 45.29% | 44.83% | 45.37% |
| mg/ml | | | |
| 54° C. | | | |
| Poncho 600 + α-terpineol at .4004 | 45.45% | 46.65% | 48.18% |
| mg/ml | | | |
| Poncho 600 + α-terpineol at .3276 | 45.29% | 46.81% | 50.65% |
| mg/ml | | | |

### Example 5

Example 5 sets forth the stability of Gaucho with an insect repellent, α-terpineol.

Table 8 describes a stability test with a combination of α-terpineol and Gaucho evaluated at room temperature, 40° C., and 54° C. at zero time, 2 days, and 8 days as confirmed by high performance liquid chromatography (HPLC). As described in Table 8, the content of imidacloprid, which is the active agent in Gaucho, exhibited chemical stability when combined with an insect and bee repellent α-terpineol for up to 54° C. for eight days.

TABLE 8
Imidacloprid content

| | zero | after | after |
|---|---|---|---|
| | time | 2 days | 8 days |
| Room Temperature | | | |
| Gaucho 600 only | 47.43% | 47.96% | 51.21% |
| Gaucho 600 + α-terpineol at .3745 | 48.59% | 47.72% | 48.21% |
| mg/ml | | | |
| Gaucho 600 + α-terpineol at .4594 | 48.19% | 48.85% | 47.89% |
| mg/ml | | | |
| 40° C. | | | |
| Gaucho 600 + α-terpineol at .4140 | 48.59% | 47.66% | 48.61% |
| mg/ml | | | |
| Gaucho 600 + α-terpineol at .5787 | 48.19% | 48.98% | 49.32% |
| mg/ml | | | |
| 54° C. | | | |
| Gaucho 600 + α-terpineol at .4154 | 48.59% | 48.82% | 50.51% |
| mg/ml | | | |
| Gaucho 600 + α-terpineol at .4392 | 48.19% | 49.32% | 53.16% |
| mg/ml | | | |

1. A method of repelling, controlling, and/or directing an insect from a seed, plant part, or plant comprising
a) treating a seed, plant part, or plant with at least one compound of Formula (I)-(IX) selected from the group consisting of: [chemical structure]
in which,
R₁ and R₂ are independently selected from methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl, alkyl substituted with halogen, F, Cl, Br, I, oxygen, hydroxyl, alkoxy, cyano, aryloxy, C═C, C≡C; nitrogen, NH2, alkyl amino, dialkyl amine trialkylamino; SH, alkylthio or where R¹ and R² are linked together to form a substituted or unsubstituted (CH₂)₃, (CH₂)₄, (CH₂)₅, (CH₂)₆, (CH₂)₇, (CH₂)₈, (CH₂)₉, (CH₂)₁₀, (CH₂)₁₁, (CH₂)₁₂, (CH₂)₁₃ ring structure;
R₃ and R₄ are individually selected from H, alkyl, methyl, ethyl, propyl, or butyl;
b) wherein said at least one compound repels, controls, and/or directs at least 80% of the insects for at least 8 hours.

2. The method according to claim 1, wherein R₁ is methyl or ethyl and R₂ is selected from the group consisting of methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl.

3. The method according to claim 1, wherein said at least one compound is a C₇-C₁₅ ketone.

4. The method according to claim 3, wherein said C₇-C₁₅ ketone is selected from the group consisting of 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

5. The method according to claim 1, wherein said insect is a pollinating insect and said pollinating insect is optionally honeybee.

6. The method according to claim 1, wherein said at least one compound repels at least 90% of the insects for at least 24 hours.

7. The method according to claim 1, wherein said at least one compound is formulated in a composition comprising an agent selected from the group consisting of camphor, camphor oil, camphor powder, tea tree oil, pine oil, rosemary powder, and rosemary oil.

8. The method according to claim 3, wherein said C₇-C₁₅ ketone compound repels a larger percentage of honeybees than an equal percent weight of a compound selected from the group consisting of camphor oil, ajowan oil, camphor powder, and rosemary oil.

9. The method according to claim 1, wherein said compound is formulated in a composition comprising an insecticide, herbicide, insecticide, and/or miticide.

10. The method according to claim 9, wherein said composition further comprises an active agent selected from the group consisting of acetamiprid, clothianidin, dinotefuran, imidacloprid, nitenpyram, thiacloprid, thiamethoxam, ethiprole, fipronil, Poncho, Gaucho, and Poncho/Votivo.

11. A method for promoting the health of an insect comprising
(a) treating a seed, plant, or plant part with a repelling, controlling, or directing compound or composition comprising a ketone, and wherein the compound or composition repels, controls, or directs at least 80% of the insects for at least 8 hours; and
(b) treating a seed, plant, or plant part with one or more of a compound or composition formulated to repel, control, or direct a pest of said insect, formulated to provide an nutritional composition to said insect, or formulated to provide an antibiotic composition to said insect.

12. The method according to claim 11, wherein the ketone compound comprises a C₇-C₁₅ ketone.

13. The method according to claim 12, wherein said C₇-C₁₅ compound is selected from the group consisting of 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

14. The method according to claim 11, wherein said insect is a pollinating insect and said pollinating insect is optionally honeybee.

15. The method according to claim 11, wherein the compound or composition repels at least 90% of the insects for at least 24 hours.

16. The method according to claim 11, wherein the compound is formulated in a composition comprising an agent selected from the group consisting of camphor, camphor oil, camphor powder, tea tree oil, pine oil, rosemary powder, and rosemary oil.

17. The method according to claim 12, wherein said C₇-C₁₅ ketone compound repels, controls, or directs a larger percentage of an insect than a composition comprising a compound selected from the group consisting of camphor oil, ajowan oil, camphor powder, and rosemary oil.

18. The method according to claim 11, wherein the compound is formulated in a composition comprising an insecticide, herbicide, insecticide, or miticide.

19. The method according to claim 18, wherein said composition further comprises an active agent selected from the group consisting of acetamiprid, clothianidin, dinotefuran, imidacloprid, nitenpyram, thiacloprid, thiamethoxam, ethiprole, fipronil, Poncho, Gaucho, and Poncho/Votivo.

20. The method of claim 18, wherein said miticide is selected from the group consisting of 1-arylimidazole, 1-aryl pyrrole, and 1-arylpyrazole.

21. The method of claim 1, wherein said at least one compound of Formula (I)-(IX) comprises a decanone compound.

22. The method of claim 1, wherein said at least one compound of Formula (I)-(IX) comprises 2-decanone.

23. The method of claim 1, wherein said at least one compound of Formula (I)-(IX) comprises 3-decanone.

24. The method of claim 1, wherein said at least one compound of Formula (I)-(IX) comprises 4-decanone.

25. The method of claim 1, wherein said at least one compound of Formula (I)-(IX) comprises 5-decanone.

26. The method of claim 1, wherein said method comprises a synergistic mixture of at least one compound of Formula (I)-(IX).

27. A seed capable of repelling, controlling, or directing an insect, wherein said seed is coated with at least one compound of Formula (I)-(IX) selected from the group consisting of: [chemical structure]
in which,
R₁ and R₂ are independently selected from methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl, alkyl substituted with halogen, F, Cl, Br, I, oxygen, hydroxyl, alkoxy, cyano, aryloxy, C═C, C≡C; nitrogen, NH2, alkyl amino, dialkyl amine trialkylamino; SH, alkylthio or where R¹ and R² are linked together to form a substituted or unsubstituted (CH₂)₃, (CH₂)₄, (CH₂)₅, (CH₂)₆, (CH₂)₇, (CH₂)₈, (CH₂)₉, (CH₂)₁₀, (CH₂)₁₁, (CH₂)₁₂, (CH₂)₁₃ ring structure; and
R₃ and R₄ are individually selected from H, alkyl, methyl, ethyl, propyl, or butyl; and
wherein said seed repels, controls, or directs at least 80% of the insects for at least 8 hours.

28. The seed of claim 27, wherein said at least one compound of Formula (I)-(IX) comprises a decanone compound.

29. The seed of claim 27, wherein said at least one compound of Formula (I)-(IX) comprises 2-decanone.

30. The seed of claim 27, wherein said at least one compound of Formula (I)-(IX) comprises 3-decanone.

31. The seed of claim 27, wherein said at least one compound of Formula (I)-(IX) comprises 4-decanone.

32. The seed of claim 27, wherein said at least one compound of Formula (I)-(IX) comprises 5-decanone.

33. The seed of claim 27, wherein said method comprises a synergistic mixture of at least one compound of Formula (I)-(IX).

34. A fertilizer composition comprising (1) fertilizer and (2) at least one compound of Formula (I)-(IX) selected from the group consisting of: [chemical structure]
in which,
R₁ and R₂ are independently selected from methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl, alkyl substituted with halogen, F, Cl, Br, I, oxygen, hydroxyl, alkoxy, cyano, aryloxy, C═C, C≡C; nitrogen, NH2, alkyl amino, dialkyl amine trialkylamino; SH, alkylthio or where R¹ and R² are linked together to form a substituted or unsubstituted (CH₂)₃, (CH₂)₄, (CH₂)₅, (CH₂)₆, (CH₂)₇, (CH₂)₈, (CH₂)₉, (CH₂)₁₀, (CH₂)₁₁, (CH₂)₁₂, (CH₂)₁₃ ring structure; and
R₃ and R₄ are individually selected from H, alkyl, methyl, ethyl, propyl, or butyl; and
wherein said seed repels, controls, or directs at least 80% of the insects for at least 8 hours.

35. The fertilizer composition of claim 34, wherein said at least one compound of Formula (I)-(IX) comprises a decanone compound.

36. The fertilizer composition of claim 34, wherein said at least one compound of Formula (I)-(IX) comprises 2-decanone.

37. The fertilizer composition of claim 34, wherein said at least one compound of Formula (I)-(IX) comprises 3-decanone.

38. The fertilizer composition of claim 34, wherein said at least one compound of Formula (I)-(IX) comprises 4-decanone.

39. The seed of claim 34, wherein said at least one compound of Formula (I)-(IX) comprises 5-decanone.

40. The seed of claim 34, wherein said method comprises a synergistic mixture of at least one compound of Formula (I)-(IX).
